(19) United States
(12) Patent Application Publication
(10) Pub. No.: US 2013/0265665 A1
(43) Pub. Date: Oct. 10, 2013

(54) CONCENTRATING SOLAR ENERGY COLLECTOR

(71) Applicant: COGENRA SOLAR, INC., Mountain View, CA (US)

(72) Inventors: Adam T. Clavelle, San Francisco, CA (US); Jason C. Kalus, San Francisco, CA (US); Nathan P. Beckett, Oakland, CA (US); Ratson Morad, Palo Alto, CA (US); Gilad Almogy, Palo Alto, CA (US)

(73) Assignee: COGENRA SOLAR, INC., Mountain View, CA (US)

(21) Appl. No.: 13/837,604

(22) Filed: Mar. 15, 2013

Related U.S. Application Data
(60) Provisional application No. 61/621,820, filed on Apr. 9, 2012.

(51) Int. Cl. G02B 5/10

(52) U.S. Cl. CPC G02B 5/10
USPC 359/853

(57) ABSTRACT

Systems, methods, and apparatus by which solar energy may be collected to provide heat, electricity, or a combination of heat and electricity are disclosed herein.

### CROSS-REFERENCE TO RELATED APPLICATIONS

This application claims benefit of priority to U.S. Provisional Application No. 61/621,820 titled “Concentrating Solar Energy Collector” and filed Apr. 9, 2012, which is incorporated herein by reference in its entirety.

### FIELD OF THE INVENTION

The invention relates generally to the collection of solar energy to provide electric power, heat, or electric power and heat.

### BACKGROUND

Alternate sources of energy are needed to satisfy ever increasing world-wide energy demands. Solar energy resources are sufficient in many geographical regions to satisfy such demands, in part, by provision of electric power and useful heat.

### SUMMARY

Systems, methods, and apparatus by which solar energy may be collected to provide electricity, heat, or a combination of electricity and heat are disclosed herein.

In one aspect, a solar energy collector comprises a first row of one or more trough reflectors extending along and attached to a first rotation shaft and a second row of one or more trough reflectors extending along and attached to a second rotation shaft that is arranged side-by-side with the first rotation shaft and oriented parallel to the first rotation shaft. The solar energy collector also comprises a first transverse support beam underlying both the first and the second rotation shafts, and a second transverse support beam underlying both the first and the second rotation shafts and spaced apart from the first transverse support beam along the rotation shafts. The first rotation shaft is pivotably supported by a first bearing on a post extending upward from the first transverse support beam and pivotably supported and driven by a first slew drive on a post extending upward from the second transverse support beam. The first rotation shaft passes through the center of the first bearing and through the center of the first slew drive. The second rotation shaft is pivotably supported by a second bearing on a post extending upward from the first transverse support beam and pivotably supported and driven by a second slew drive on a post extending upward from the second transverse support beam. The second rotation shaft passes through the center of the second bearing and through the center of the second slew drive. The positions of the first bearing and the first slew drive along the first rotation shaft and of the second bearing and the second slew drive along the second rotation shaft are adjustable to match the positions of the first and second transverse support beams to the positions of load bearing elements of a surface underlying the solar energy collector. The underlying surface may be a roof of a building, for example.

The positions of the first bearing and the first slew drive along the first rotation shaft and of the second bearing and the second slew drive along the second rotation shaft may be slidably adjustable along their rotation shafts. The first and second transverse support beams may be oriented parallel to each other, and may be oriented perpendicular to the rotation shafts.

The solar energy collector may comprise transverse reflector supports attached to and extending transversely to the rotation shafts to support the trough reflectors. The solar energy collector may comprise a plurality of receivers. The receivers may comprise solar cells, coolant channels accommodating flow of liquid coolant through the receiver, or solar cells and coolant channels accommodating flow of liquid coolant through the receivers. Each receiver may be supported above a corresponding trough reflector by, for example, one or more receiver supports extending upward from transverse reflector supports that support the corresponding trough reflector, with each receiver fixed in position with respect to its corresponding trough reflector.

Each trough reflector may comprise a plurality of linearly extending reflective elements oriented with their long axes parallel to the trough reflector's rotation shaft, arranged side-by-side in a direction transverse to that rotation shaft, and fixed in position with respect to each other.

Along each rotation shaft, the trough reflectors may be arranged end-to-end with ends of adjacent trough reflectors vertically offset with respect to each other. The trough reflectors may be arranged to form a repeating pattern of tilted trough reflectors, for example. The vertically offset ends of adjacent trough reflectors may overlap. The reflectors may be arranged so that for each pair of vertically offset adjacent trough reflector ends, the upper trough reflector is located further from the earth's equator than is the lower trough reflector.

Each trough reflector may comprise a plurality of linearly extending reflective elements arranged side-by-side on an upper surface of a flexible panel and oriented parallel to the trough reflector's rotation shaft. In such variations that also comprise transverse reflector supports attached to and extending transversely to the rotation shafts to support the trough reflectors, attachment of the trough reflectors to the transverse reflector supports may force ends of the flexible panels against curved edges of the transverse reflector supports to thereby impose a desired concentrating curvature on the trough reflectors.

The solar energy collector may comprise a plurality of longitudinal reflector supports extending parallel to each rotation shaft to support the trough reflectors and a plurality of transverse reflector supports extending transversely from each rotation shaft to support the longitudinal reflector supports, with each transverse reflector support located at or near an end of a trough reflector. In such variations, when the longitudinal reflector supports are in a free state unattached to the solar energy collector they may have a curvature that, in the assembled solar energy collector, is flattened or substantially flattened by the force of gravity. The free-state curvature of the longitudinal reflector supports may thereby compensate for the force of gravity on the trough reflectors to prevent sagging of each trough reflector between its supporting transverse reflector supports.

In another aspect, a concentrating solar energy collector comprises a linearly extending receiver and a reflector comprising a plurality of linearly extending reflective elements oriented with their long axes parallel to a long axis of the receiver. The reflective elements are arranged side-by-side in a direction transverse to the long axis of the receiver and fixed in position with respect to each other. The solar energy collector also comprises a linearly extending support structure that accommodates rotation of the receiver, rotation of the reflector, or rotation of the receiver and the reflector about a rotation axis parallel to the long axis of the receiver. Linearly extending gaps between adjacent linearly extending reflective elements reduce wind load on the reflector compared to the same reflector without the gaps.

The gaps may be provided by spacing the linearly extending reflective elements apart horizontally, by spacing the linearly extending reflective elements apart vertically, or by spacing the linearly extending reflective elements apart horizontally and vertically. The reflector formed by the linearly extending reflective elements may have, for example, a parabolic or substantially parabolic shape.

The receiver may comprise solar cells, coolant channels accommodating flow of liquid coolant through the receiver, or solar cells and coolant channels accommodating flow of liquid coolant through the receiver.

These and other embodiments, features and advantages of the present invention will become more apparent to those skilled in the art when taken with reference to the following more detailed description of the invention in conjunction with the accompanying drawings that are first briefly described.

### BRIEF DESCRIPTION OF THE DRAWINGS

FIGS. 1A and 1B show front (FIG. 1A) and rear (FIG. 1B) perspective views of an example solar energy collector; FIG. 1C shows a graph of a parabolic surface and its symmetry plane, by which features of the solar energy collector of FIGS. 1A and 1B may be better understood.

FIGS. 2A and 2B show, in perspective views, details of example transverse reflector supports mounted to a rotation shaft and details of example receiver supports attached to the transverse reflector supports.

FIGS. 3A and 3B show a cross-sectional view of a longitudinal reflector support (FIG. 3A) and a cross-sectional view of the longitudinal reflector support attached to a projection on a transverse reflector support (FIG. 3B).

FIGS. 4A and 4B show the use of example receiver mounting brackets at the intersection of two adjacent receivers (FIG. 4A) and with a receiver at an end of a solar energy collector (FIG. 4B).

FIGS. 5A-5D show a perspective view of an example reflector/receiver support structure comprising transverse frame rails, master and slave support posts, and rotation shafts (FIG. 5A), perspective views showing details of an example master support post (FIGS. 5B, 5C), and a perspective view showing details of an example slave support post (FIG. 5D).

FIGS. 6A and 6B show end views of the example solar energy collector of FIGS. 1A-1B in a safe position (FIG. 6A) and in a stow position (FIG. 6B).

FIGS. 7A and 7B show example reflector arrangements that decrease wind load on a solar energy collector by spacing adjacent linearly extending reflective elements apart in the horizontal (FIG. 7A) and vertical (FIG. 7B) directions.

FIG. 8A shows a cross-sectional view of another example transverse reflector support, and FIG. 8B shows a side view of a solar energy collector comprising the example transverse reflector support of FIG. 8A.

FIG. 9A shows a perspective view of an example reflector-panel assembly, FIG. 9B shows a cross-sectional view of the example reflector-panel assembly flexed into a curved profile, FIG. 9C shows a cross-sectional view of the example reflector-panel assembly in a relaxed flat profile, FIG. 9D shows a close-up cross-sectional view of a portion of the example reflector-panel assembly, and FIG. 9E shows a close-up cross-sectional view of a clinch joint joining the flange panel of a longitudinal reflector support to the flexible panel in a reflector-panel assembly.

FIG. 10A shows a perspective view of the underside of an example reflector-panel assembly, and FIG. 10B shows a perspective view of two example reflector-panel assemblies and an example transverse reflector support.

FIGS. 11A-11B show, respectively, perspective and plan views of an example bracket configured to attach a longitudinal reflector support in an example reflector-panel assembly to an example transverse reflector support.

FIG. 12A shows a perspective view of two example reflector-panel assemblies attached to an example transverse reflector support in a vertically offset and overlapping manner, and FIGS. 12B-12C show side views of such vertically offset and overlapping reflector-panel assemblies.

FIG. 13 shows an example pre-bent longitudinal reflector support.

### DETAILED DESCRIPTION

The following detailed description should be read with reference to the drawings, in which identical reference numbers refer to like elements throughout the different figures. The drawings, which are not necessarily to scale, depict selective embodiments and are not intended to limit the scope of the invention. The detailed description illustrates by way of example, not by way of limitation, the principles of the invention. This description will clearly enable one skilled in the art to make and use the invention, and describes several embodiments, adaptations, variations, alternatives and uses of the invention, including what is presently believed to be the best mode of carrying out the invention.

As used in this specification and the appended claims, the singular forms “a,” “an,” and “the” include plural referents unless the context clearly indicates otherwise. Also, the term “parallel” is intended to mean “parallel or substantially parallel” and to encompass minor deviations from parallel geometries rather than to require that any parallel arrangements described herein be exactly parallel. Similarly, the term “perpendicular” is intended to mean “perpendicular or substantially perpendicular” and to encompass minor deviations from perpendicular geometries rather than to require that any perpendicular arrangements described herein be exactly perpendicular.

This specification discloses apparatus, systems, and methods by which solar energy may be collected to provide electricity, heat, or a combination of electricity and heat.

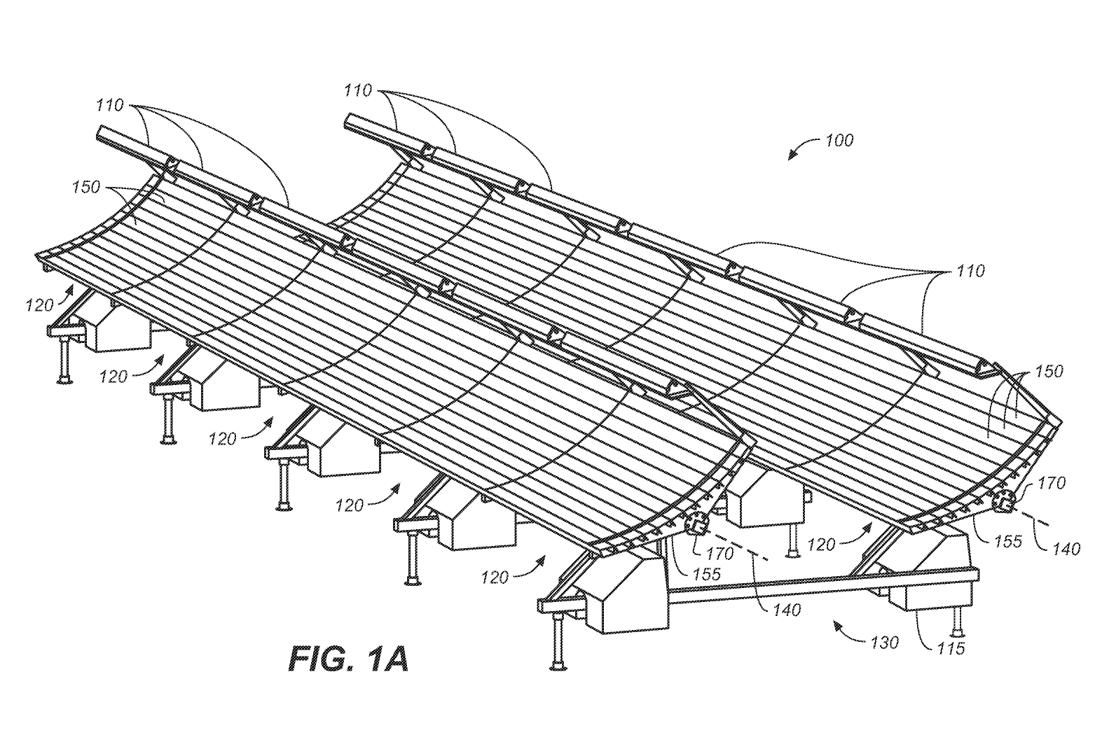

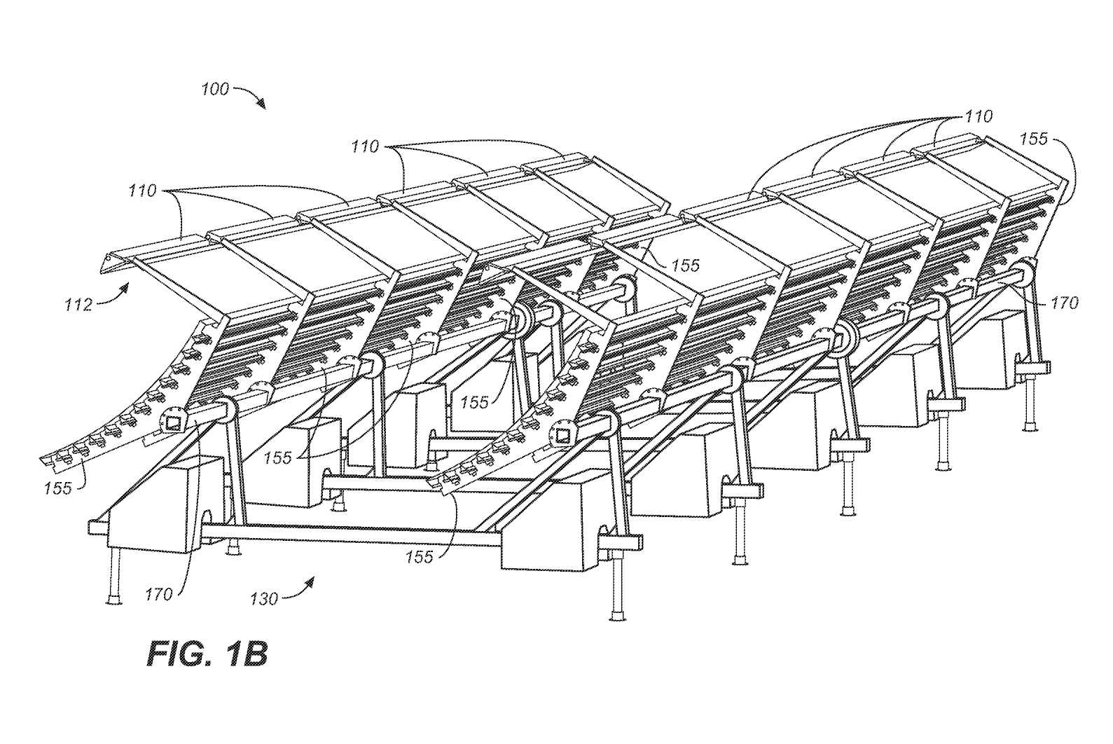

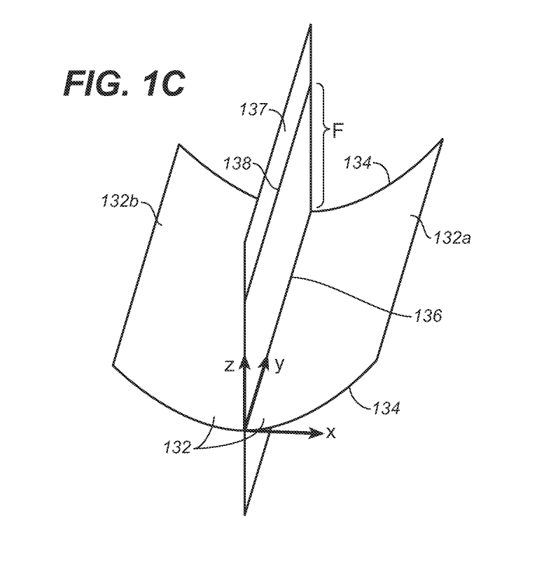

Referring now to FIGS. 1A and 1B, an example solar energy collector 100 comprises two or more rows of solar energy reflectors and receivers with the rows arranged parallel to each other and side-by-side. Each such row comprises one or more linearly extending reflectors 120 arranged in line so that their linear foci are collinear, and one or more linearly extending receivers 110 arranged in line and fixed in position with respect to the reflectors, with each receiver comprising a surface 112 located at or approximately at the linear focus of a corresponding reflector. A support structure 130, shared between two or more such adjacent and parallel rows of reflectors and receivers, pivotably supports the reflectors and the receivers of the two or more such rows to accommodate rotation of the reflectors and the receivers in each row about a rotation axis 140 parallel to the linear focus of the reflectors in that row. In operation, the reflectors and receivers are rotated about their rotation axes 140 to track the position of the sun so that solar radiation incident on reflectors 120 is concentrated to a linear focus onto their corresponding receivers 110. That is, the reflectors and receivers track the position of the sun so that for each row of reflectors 120 the sun lies in a plane containing the optical axes of the reflectors. (Any path perpendicular to the linear foci of reflectors 120 for which light rays traveling along that path are focused by the reflectors onto the centerline of the receivers is an optical axis of reflectors 120 and collector 100).

In other variations, a solar energy collector otherwise substantially identical to that of FIGS. 1A and 1B may comprise only a single row of reflectors 120 and receivers 110, with support structure 130 modified accordingly.

As is apparent from FIGS. 1A and 1B, solar energy collector 100 may be viewed as having a modular structure with reflectors 120 and receivers 110 having approximately the same length, and each pairing of a reflector 120 with a receiver 110 being an individual module. Solar energy collector 100 may thus be scaled in size by adding or removing such interconnected modules at the ends of solar energy collector 100, with the configuration and dimensions of support structure 130 adjusted accordingly.

In the example of FIGS. 1A and 1B, the reflective surface of each reflector 120 is or approximates a portion of a parabolic surface. Referring now to the graph in FIG. 1C, a parabolic surface 132 may be constructed mathematically (in a coordinate space spanned by axes x, y, z, as shown, for example) by translating a parabola 134 along an axis 136 (in this example, the y axis) perpendicular to the plane of the parabola (in this example, the x, z plane). Symmetry plane 137 (the y, z plane in this example) divides parabolic surface 132 into two symmetric halves 132a, 132b. The linear focus 138 of the parabolic surface is oriented perpendicular to the plane of the parabola and lies in symmetry plane 137 at a distance F (the focal length) from the parabolic surface. For parabolic reflective surfaces as in this example, the optical axes are in the symmetry plane of the surface and oriented perpendicularly to the linear focus of the surface. In this example, the z axis is an optical axis of the reflector.

Referring again to FIGS. 1A and 1B, in the illustrated example the reflective surface of each reflector 120 is or approximates a portion of a parabolic surface taken entirely from one side of the symmetry plane of the parabolic surface (e.g., from 132a or 132b in FIG. 1C, but not both). In other variations, the reflective surface of reflector 120 is or approximates a portion of a parabolic surface taken from primarily one side of the symmetry plane of the parabolic surface (e.g., more than 50%, more than 60%, more than 70%, more than 80%, more than 90%, or more than 95% of the reflective surface is from one side of the symmetry plane of the parabolic surface), but includes a portion of the parabolic surface on the other side of the symmetry plane, as well.

Although each reflector 120 is parabolic or approximately parabolic in the illustrated example, reflectors 120 need not have a parabolic or approximately parabolic reflective surface. In other variations of solar energy collectors disclosed herein, reflectors 120 may have any curvature suitable for concentrating solar radiation onto a receiver.

In the example of FIGS. 1A and 1B, each reflector 120 comprises a plurality of linearly extending reflective elements 150 (e.g., mirrors) oriented parallel to the linear focus of the reflector and fixed in position with respect to each other and with respect to the corresponding receiver. As shown, linear reflective elements 150 each have a length equal or approximately equal to that of reflector 120 and are arranged side-by-side to form the reflector. In other variations, however, some or all of linear reflective elements 150 may be shorter than the length of reflector 120, in which case two or more linearly extending reflective elements 150 may be arranged end-to-end to form a row of linearly extending reflective elements along the length of the reflector, and two or more such rows may be arranged side-by-side to form a reflector 120. Typically, the lengths of linearly extending reflective elements 150 are much greater than their widths. Hence, linearly extending reflective elements 150 typically have the form of reflective slats.

In the illustrated example, linearly extending reflective elements 150 each have a width of about 123 millimeters (mm) and a length of about 2751 mm. In other variations, linear reflective elements 150 may have, for example, widths of about 100 mm to about 200 mm and lengths of about 1000 mm to about 4000 mm. Linearly extending reflective elements 150 may be flat or substantially flat, as illustrated, or alternatively may be curved along a direction transverse to their long axes to individually focus incident solar radiation on the corresponding receiver.

Although in the illustrated example each reflector 120 comprises linearly reflective elements 150, in other variations a reflector 120 may be formed from a single continuous reflective element, from two reflective elements, or in any other suitable manner.

Linearly extending reflective elements 150, or other reflective elements used to form a reflector 120, may be or comprise, for example, any suitable front surface mirror or rear surface mirror. The reflective properties of the mirror may result, for example, from any suitable metallic or dielectric coating or polished metal surface.

In variations in which reflectors 120 comprise linearly extending reflective elements 150 (as illustrated), solar energy collector 100 may be scaled in size and concentrating power by adding or removing rows of linearly extending reflective elements 150 to or from reflectors 120 to make reflectors 120 wider or narrower. The width of support structure 130 transverse to the optical axis of reflectors 120, and the width of transverse reflector supports 155 (discussed below), may be adjusted accordingly.

Referring again to FIGS. 1A and 1B, each receiver 110 may comprise solar cells (not shown) located, for example, on receiver surface 112 to be illuminated by solar radiation concentrated by a corresponding reflector 120. In such variations, each receiver 110 may further comprise one or more coolant channels accommodating flow of liquid coolant in thermal contact with the solar cells. For example, liquid coolant (e.g., water, ethylene glycol, or a mixture of the two) may be introduced into and removed from a receiver 110 through manifolds (not shown) at either end of the receiver located, for example, on a rear surface of the receiver shaded from concentrated radiation. Coolant introduced at one end of the receiver may pass, for example, through one or more coolant channels (not shown) to the other end of the receiver from which the coolant may be withdrawn. This may allow the receiver to produce electricity more efficiently (by cooling the solar cells) and to capture heat (in the coolant). Both the electricity and the captured heat may be of commercial value.

FIGS. 1A and 1B also show optional coolant storage tanks 115 supported by support structure 130. Coolant may be stored in tanks 115 and pumped by a pump (not shown) from or through tanks 115 to receivers 110 (through coolant conduits, e.g., not shown) for heating or to an external use of heated coolant.

In variations in which coolant is flowed through receivers 110, the receivers may comprise top covers that are substantially transparent to solar radiation. This may create a green-house effect in which direct solar illumination of the top cover of a receiver further heats the receiver and thus further heats the coolant. Such substantially transparent receiver top covers may be formed from a polycarbonate plastic, for example.

In some variations, the receivers comprise solar cells but lack channels through which a liquid coolant may be flowed. In other variations, the receivers may comprise channels accommodating flow of a liquid to be heated by solar energy concentrated on the receiver, but lack solar cells. Solar energy collector 100 may comprise any suitable receiver. In addition to the examples illustrated herein, suitable receivers may include, for example, those disclosed in U.S. patent application Ser. No. 12/622,416, filed Nov. 19, 2009, titled “Receiver For Concentrating Photovoltaic-Thermal System;” and U.S. patent application Ser. No. 12/774,436, filed May 5, 2010, also titled “Receiver For Concentrating Photovoltaic-Thermal System;” both of which are incorporated herein by reference in their entirety.

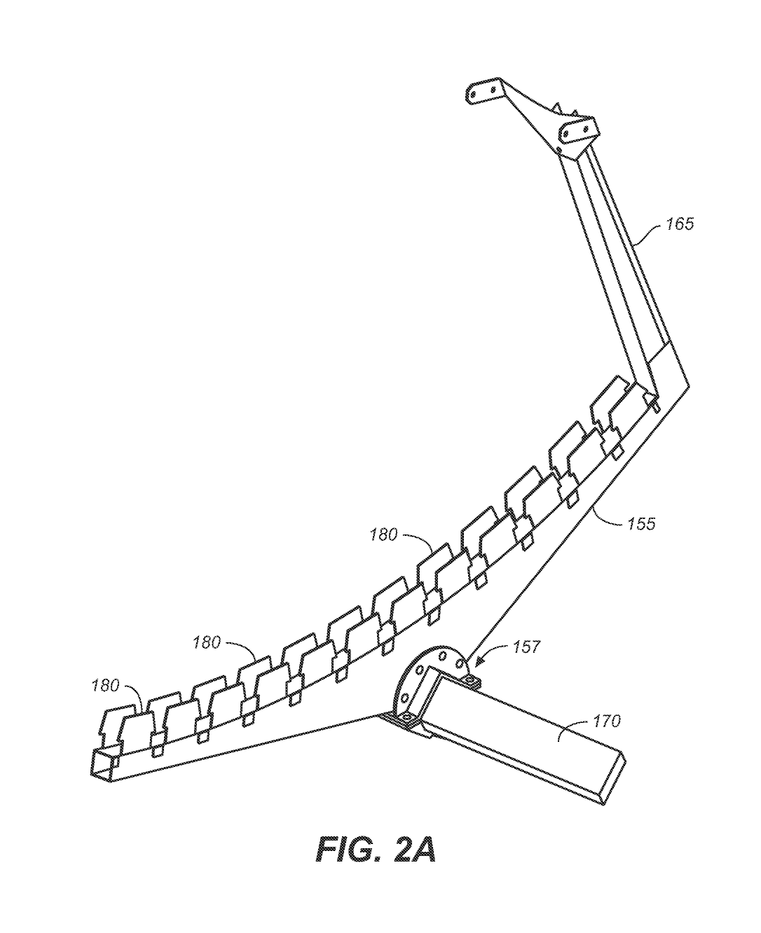

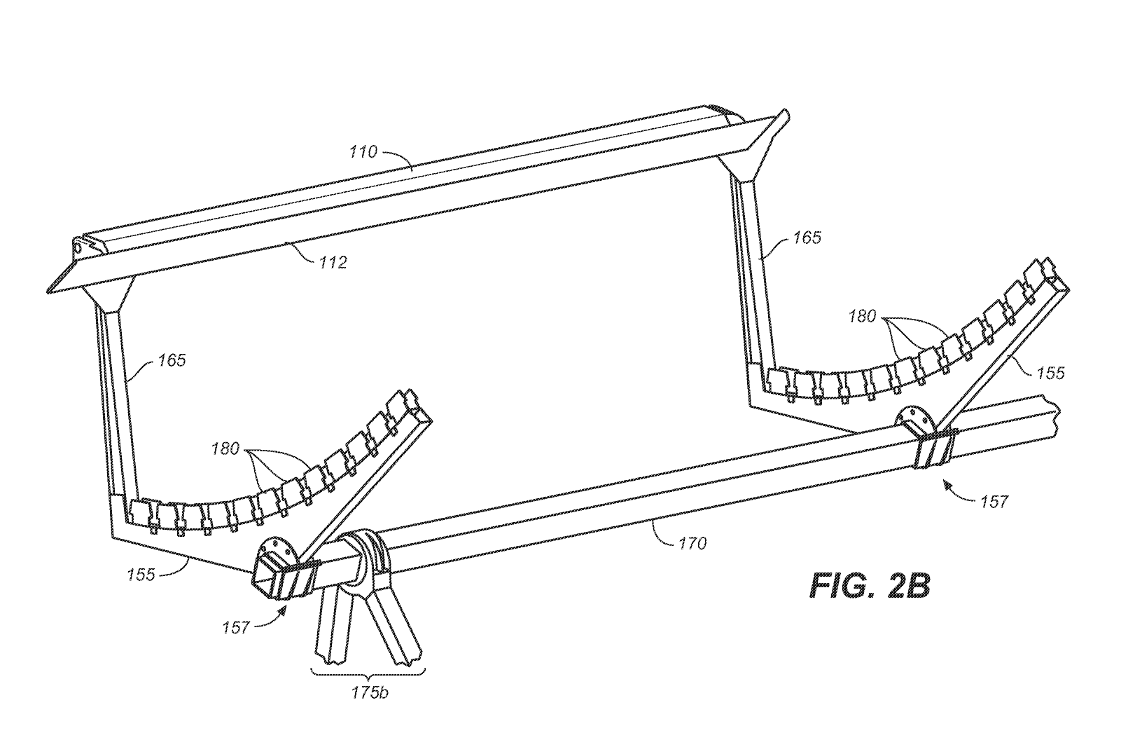

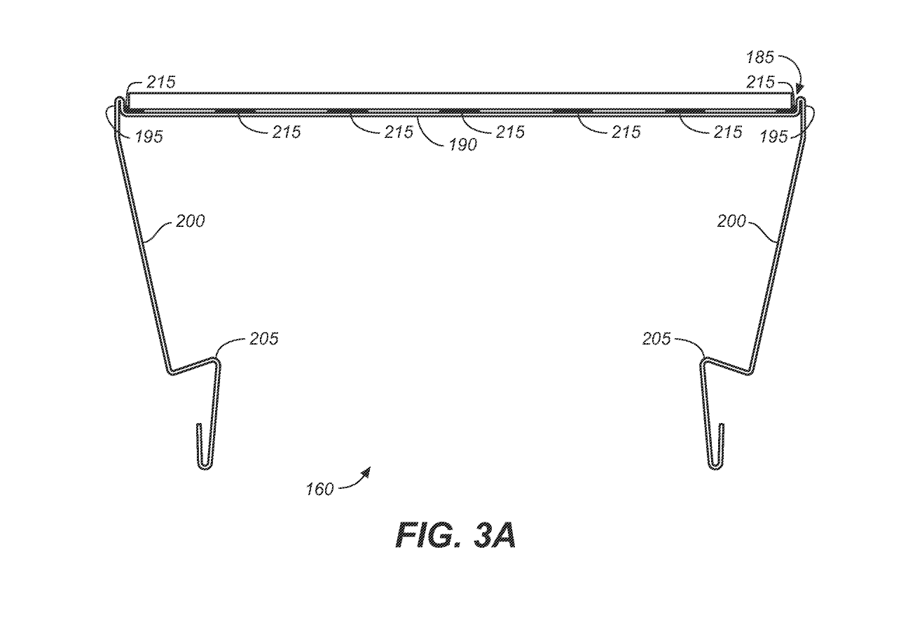

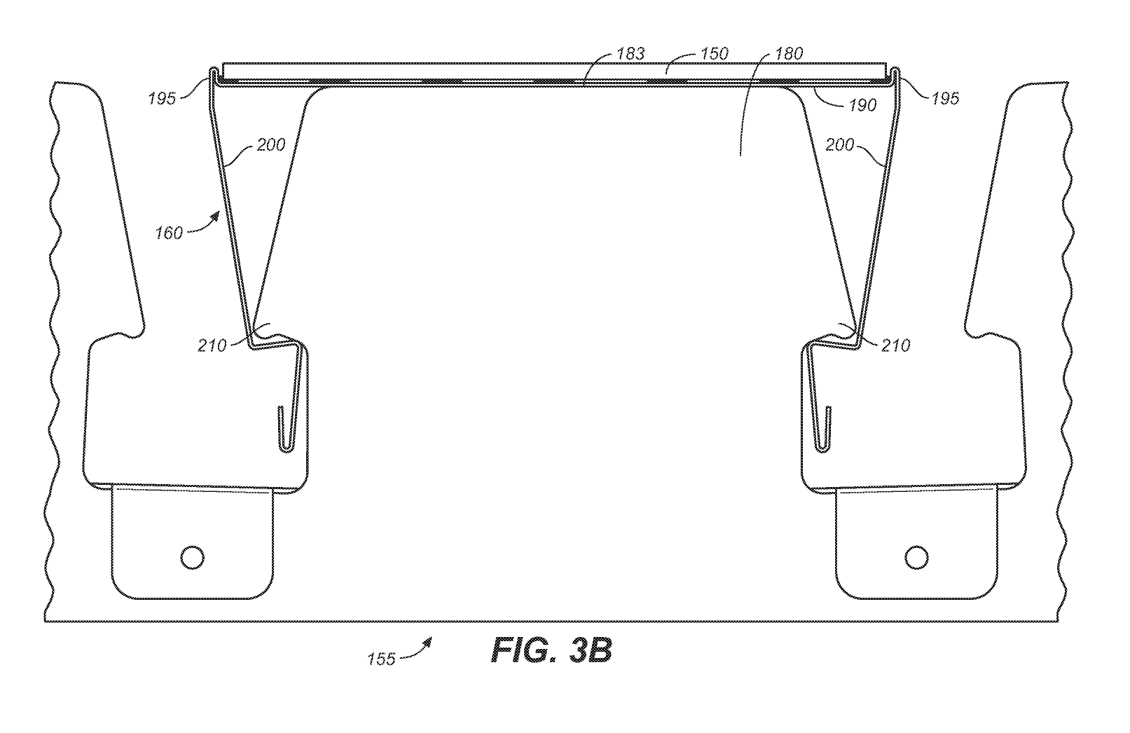

Referring again to FIGS. 1A and 1B as well as to FIGS. 2A, 2B, 3A, and 3B, in the illustrated example support structure 130 comprises a plurality of transverse reflector supports 155 and a plurality of longitudinal reflector supports 160, which together support linearly extending reflective elements 150 of reflectors 120 as follows. Each transverse reflector support 155 extends transversely to the rotation axis 140 of the reflector 120 it supports. Each longitudinal reflector support 160 supports a linearly extending reflective element 150, or a row of linearly extending reflective elements 150 arranged end-to-end, and extends parallel to the rotation axis of the reflector 120 of which its linearly extending reflective elements 150 form a part. Transverse reflector supports 155 support longitudinal reflector supports 160 and thus reflector 120.

Support structure 130 also comprises a plurality of receiver supports 165 each connected to and extending from an end, or approximately an end, of a transverse reflector support to support a receiver 110 over its corresponding reflector 120. As illustrated, each reflector 120 is supported by two transverse reflector supports 155, with one transverse reflector support at each end of the reflector. Similarly, each receiver 110 is supported by two receiver supports 165, with one receiver support at each end of the receiver. Other configurations using different numbers of transverse reflector supports per reflector and different numbers of receiver supports per receiver may be used, as suitable.

In the illustrated example, each of the transverse reflector supports 155 for a row of reflectors 120 is attached to a rotation shaft 170 which provides for rotation of the reflectors and receivers in that row about their rotation axis 140, which is coincident with rotation shaft 170. Rotation shafts 170 are pivotably supported by master posts 175a and slave posts 175b, as described in more detail below. In other variations, any other suitable rotation mechanism may be used.

In the example of FIGS. 2A and 2B, transverse reflector support 155 is attached to rotation shaft 170 with a two-piece clamp 157. Clamp 157 has an upper half attached (for example, bolted) to transverse reflector support 155 and conformingly fitting an upper half of rotation shaft 170. Clamp 157 has a lower half that conformingly fits a lower half of rotation shaft 170. The upper and lower halves of clamp 157 are attached (for example, bolted) to each other and tightened around rotation shaft 170 to clamp transverse reflector support 155 to rotation shaft 170. In some variations, the rotational orientation of transverse reflector support 155 may be adjusted with respect to the rotation shaft by, for example, about +/−5 degrees. This may be accomplished, for example, by attaching clamp 157 to transverse reflector support 155 with bolts that pass through slots in the upper half of clamp 157 to engage threaded holes in transverse reflector support 155, with the slots configured to allow rotational adjustment of transverse reflector support 155 prior to the bolts being fully tightened.

In the illustrated example transverse reflector supports 155 each comprise two parallel and identical or substantially identical rows of upward pointing projections (e.g., tabs) 180 arranged side-by-side along the length of the transverse reflector support transverse to rotation shaft 170. The two rows of projections 180 are spaced apart from each other in a direction parallel to rotation shaft 170. In the illustrated example, the spacing between the two rows of projections on a transverse reflector support is about 50 mm. In other variations, the two rows of projections may be spaced apart from each other by, for example, about 30 mm to about 100 mm.

Away from either end of a row of reflectors 120, typically each of the projections 180 in one row of projections supports an end of a corresponding one of the longitudinal reflector supports 160 for a first reflector 120, and each of the projections 180 in the other row of projections supports an end of a corresponding one of the longitudinal reflector supports 160 for another reflector 120 located on the opposite side of the transverse reflector support from the first reflector 120. A single transverse reflector support 155 may thus support an end of one reflector 120 and the adjacent end of another reflector 120. Two adjacent transverse reflector supports 155 (FIG. 2B) support a reflector 120 between them, with the longitudinal reflector supports 160 for the reflector supported at one end by a row of projections 180 on one of the transverse reflector supports 155 and supported at the other end by a row of projections 180 on the other transverse reflector support 155.

At an end of a row of reflectors 120, typically both rows of projections 180 on the outermost transverse reflector support 155 support the outermost ends of the longitudinal reflector supports 160 in the outermost reflector 120. This arrangement is shown in FIG. 1A, for example, by the parallel dashed lines running perpendicular to linearly extending reflective elements 150 at the ends of the rows of reflectors 120. These parallel dashed lines are intended to indicate the location of projections 180, on outermost transverse reflector supports 155, beneath linear extending reflective elements 150 and longitudinal reflector supports 160. The dashed lines are not meant to indicate features actually visible in this perspective view of solar energy collector 100.

To enable both rows of projections 180 on an outermost transverse reflector support 155 to support the same longitudinal reflector supports, the transverse reflector support 155 may be positioned closer to its neighboring transverse reflector support than the typical spacing between transverse reflector supports in the interior of the solar energy collector.

This arrangement with both rows of projections 180 of the outermost reflector support 155 supporting the same longitudinal reflector supports allows the outer ends of the outer reflectors 120 to be better secured to support structure 130. This may be advantageous because the outermost reflectors 120 may experience wind loads greater than those experienced by the interior reflectors 120.

In the illustrated example, upper surfaces or edges 183 of projections 180 (FIG. 3B) provide reference surfaces that orient longitudinal reflector supports 160, and thus the linearly extending reflective elements 150 they support, in a desired orientation with respect to a corresponding receiver 110 with a precision of, for example, about 0.5 degrees or better (i.e., tolerance less than about 0.5 degrees). In other variations, this tolerance may be, for example, greater than about 0.5 degrees.

Referring now to FIG. 3A as well as to FIG. 3B, in the illustrated example longitudinal reflector supports 160 snap-on to projections 180 in a self-locking manner. FIGS. 3A and 3B show a cross-sectional view of an example longitudinal reflector support 160 taken perpendicularly to its long axis. (The full three dimensional structure of this example longitudinal reflector support 160, which has the form of a long inverted trough, may be generated by translating the illustrated cross section along the long axis of longitudinal reflector support 160, that is, into the page of FIGS. 3A and 3B). In the illustrated example, longitudinal reflector support 160 has an upper tray portion 185 comprising a flat tray bottom 190 and tray side walls 195, and lower inward slanting side walls 200 each comprising a protrusion 205 formed by an inward bend of side wall 200 followed by a downward bend of side wall 200.

The position and shape of protrusions 205 are selected to substantially match or complement the position and shape of corresponding protrusions 210 on the sides of projections 180. In addition, the thickness and material from which longitudinal reflector support 160 is formed are chosen such that sidewalls 200 are sufficiently elastic that they may flex outwardly sufficiently to pass side wall protrusions 205 over protrusions 210 but will afterwards experience a restoring force clamping side wall protrusions 205 into engagement with the undersides of protrusions 210. Longitudinal reflector support 160 may in this way be secured or locked to projection 180 by forces pulling flat tray bottom 190 against projection reference surface 183. A longitudinal reflector support exhibiting this self-locking feature may be provided, for example, by rolling, folding, or otherwise forming a sheet of pre-galvanized steel having a thickness of about 0.6 mm into the illustrated shape.

More generally, longitudinal reflector supports 160 may snap-on to transverse reflector supports 155 through the engagement of any suitable complementary interlocking features on longitudinal reflector support 160 and transverse reflector support 155. Slots and locking tabs, or protrusions and recesses, for example, may be used in other variations.

In the illustrated example, longitudinal reflector supports 160 are about 2753 mm long and have upper tray portions about 125 mm wide (sized to accommodate a reflective element). In other variations, longitudinal reflector supports 160 are about 1000 mm to about 4000 mm long and have upper tray portions about 100 mm to about 200 mm wide.

Linearly extending reflective elements 150 may be attached to longitudinal reflector supports 160 with, for example, glue or other adhesive. Any other suitable method of attaching the reflective elements to the longitudinal reflector support may be used, including screws, bolts, rivets and other similar mechanical fasteners, and clamps or spring clips.

In addition to attaching linear reflective element 150 to longitudinal reflector support 160, in the illustrated example glue or adhesive 215 positioned between the outer edges of linearly extending reflective elements 150 and tray side walls 195 may also seal edges of the reflective elements and thereby prevent corrosion of the reflective elements. This may reduce any need for a sealant separately applied to the edges of the reflective elements. Glue or adhesive 215 positioned between the bottom of the linearly extending reflective element and flat tray bottom 190 of the longitudinal support may mechanically strengthen the reflective element. Further, flat tray bottom 190 may provide sufficient protection to the rear surface of the reflective element to reduce any need for a separate protective coating on that surface. A coating of paint on the rear surfaces of the reflective elements may be sufficient additional protection, for example.

Transverse reflector supports 150 comprising projections and complementary snap-on longitudinal reflector supports 160 as disclosed herein may be used to support linearly extending reflective elements in a solar energy collector having any suitable configuration. The particular configurations of support structure and rotation mechanism shown in the illustrated examples are not intended to imply any limit on the use of such transverse reflector supports and snap-on longitudinal reflector supports. Any other suitable support structures and rotation mechanisms may be used in combination with such transverse reflector supports and snap-on longitudinal reflector supports.

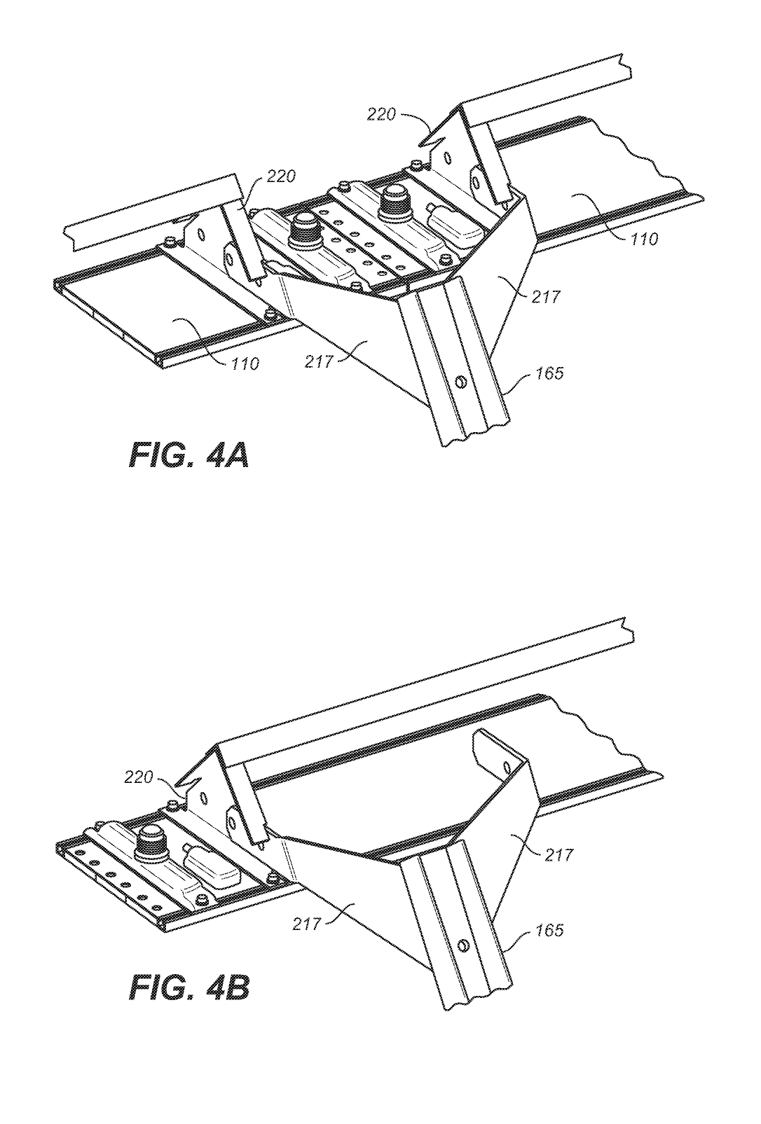

Referring now to FIG. 4A, receiver supports 165 may be attached by a pair of receiver support brackets 217 to receiver brackets 220 on the ends of adjacent receivers 110 to support the receivers over their corresponding reflectors. As noted above, at the end of a row of reflectors the position of the outermost transverse reflector support 155, and thus the outermost receiver support 165, may be offset inwardly from the outer end of the reflector. As shown in FIG. 4B, in such cases the receiver support 165 may be attached by its outer bracket 217 to the bracket 220 at the outer end of the outermost receiver 110.

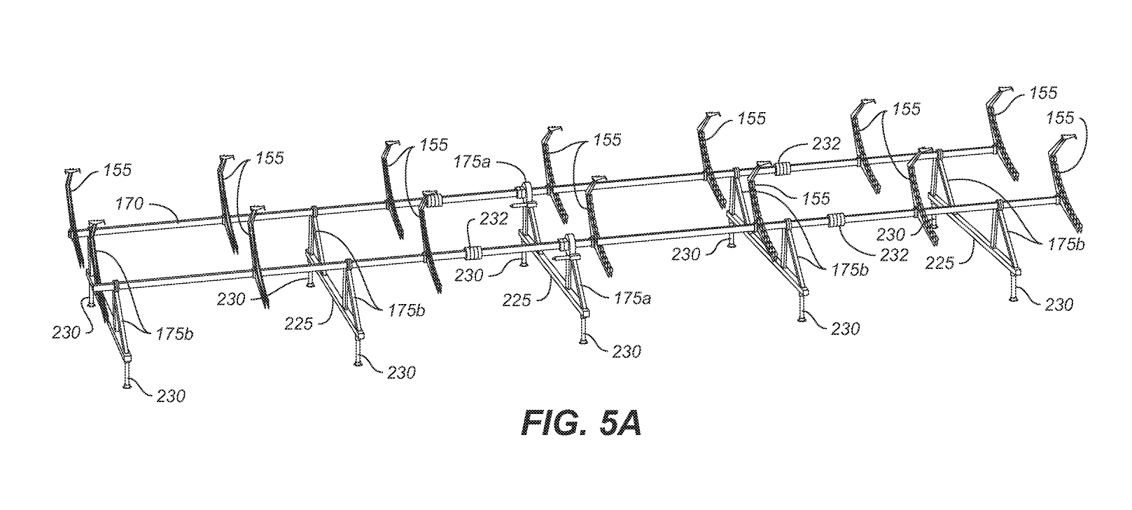

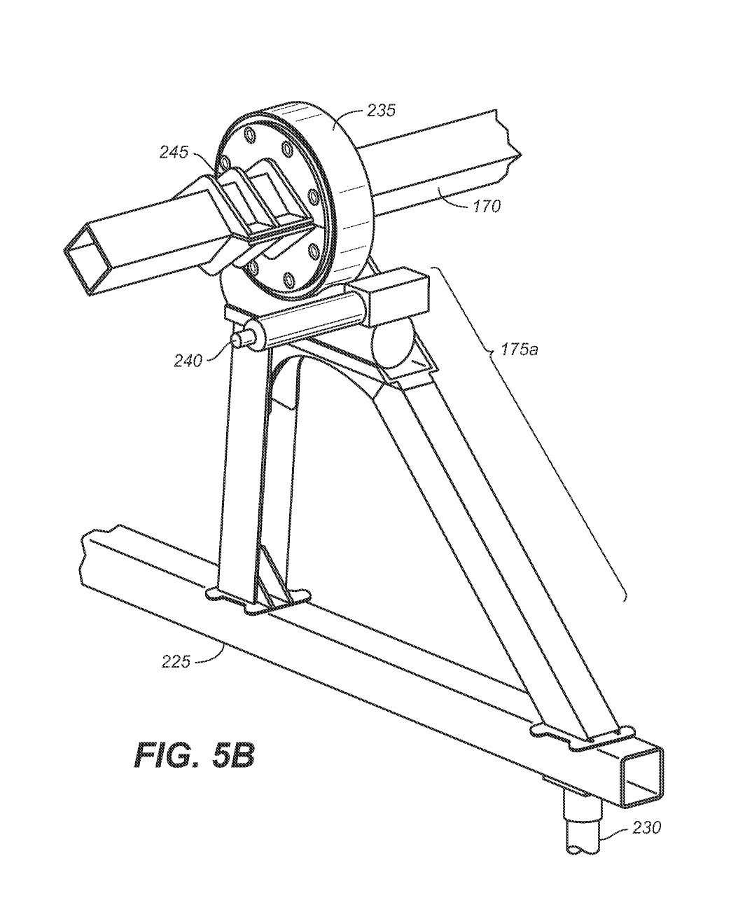

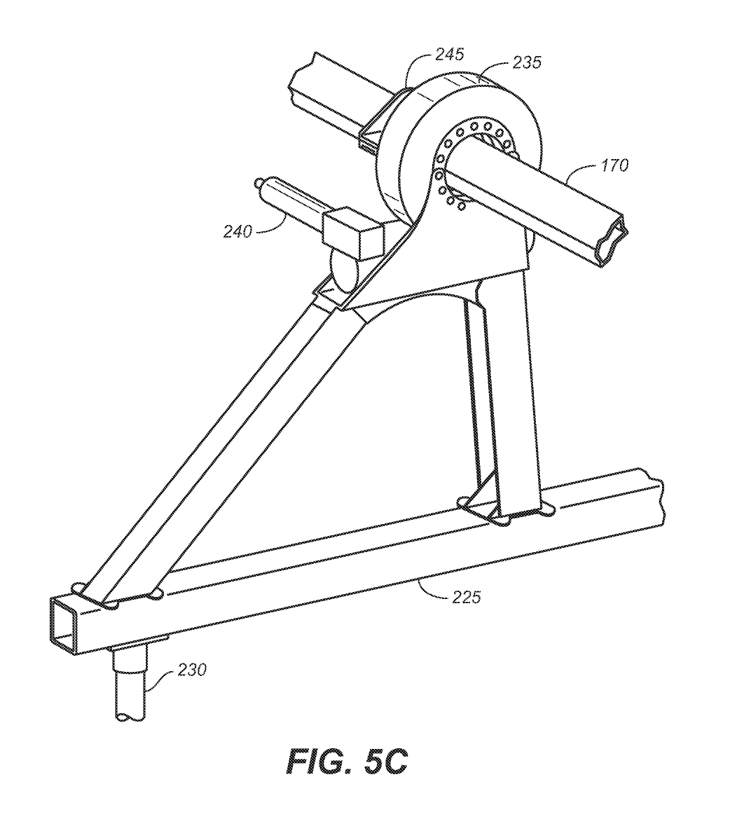

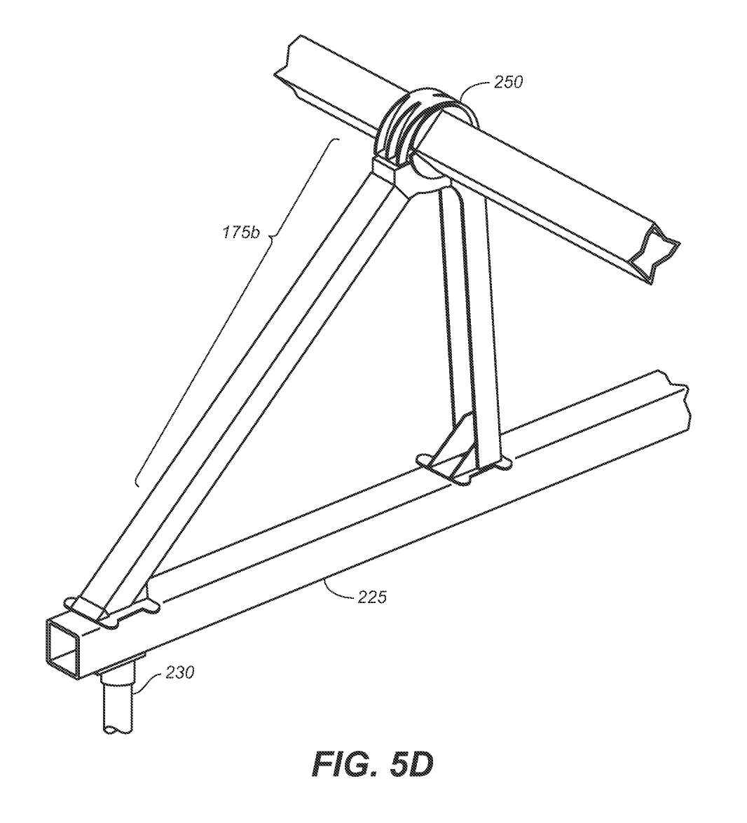

FIG. 5A shows the solar energy collector of FIGS. 1A and 1B with the reflectors and receivers removed to better show underlying support structure 130. In the illustrated example, support structure 130 comprises rotation shafts 170 pivotably supported above transverse frame rails (i.e., transverse beams) 225 by master posts 175a and slave posts 175b, which are configured to allow rotation shafts 170 to rotate around their long axes. Transverse frame rails 225 are supported above an underlying surface by posts 230. The underlying surface may be, for example, at ground level, on a rooftop, or in any other suitable location.

Rotation shafts 170 and transverse frame rails 225 are typically oriented perpendicularly to each other, as illustrated. In the illustrated example, rotation shafts 170 have two functions: they enable rotation of a row of reflectors and receivers to track the position of the sun, and they are longitudinal frame rails of support structure 130 providing strength and rigidity along their axes.

As explained in more detail below with reference to FIGS. 5B-5D, in the illustrated example the positions of master posts 175a and slave posts 175b may be easily adjusted along the length of rotation shafts 170, allowing the load from the supported solar energy collector to be distributed to match load-bearing elements in an underlying structure such as a roof, for example. The positions of master posts 275a and slave posts 275b may be adjusted independently of the positions of the reflectors and receivers supported by support structure 130.

Rotation shafts 170 may be formed, for example from steel tubing have a square cross-section with a side length of, for example, about 100 mm to about 150 mm, and wall thicknesses of, for example, about 3 mm to about 10 mm. A rotation shaft 170 may be formed from a single continuous tube. Alternatively, a rotation shaft may be formed from two or more lengths of tube joined together. Such joining may be accomplished mechanically, or by welding, or by any other suitable method. In the illustrated example, rotation shafts 170 are formed by joining shorter lengths of tube using mechanical splices 232, which have the form of clamps that conform to the cross-sectional shape of the tube and overlap the joint between two shorter lengths of tube. The splice 232 clamps to both pieces of tube, joining them together in a collinear orientation.

Referring now to FIGS. 5B and 5C, master posts 175a each comprise a slew drive 235 which may be driven by a motor 240 to rotate rotation shaft 170 about its rotation axis. In the illustrated example, rotation shaft 170 passes through the center of slew drive 235 and is clamped to slew drive 235 by a clamp 245, which is in turn attached (for example, bolted) to a rotating drive ring on slew drive 235. Clamp 245 has upper and lower halves, conformingly fitting the cross section of rotation shaft 170, that may be tightened around rotation shaft 170 (using bolts, for example) to secure rotation shaft 170 to slew drive 235. Clamp 245 may be loosened to allow master post 175a to be slidably positioned along rotation shaft 170.

Referring now to FIG. 5D, slave posts 175b each comprise a split rotation bearing 250 through which rotation shaft 170 passes. An upper half of the rotation bearing may be removed to allow rotation shaft 170 to be installed on slave post 175b or to allow the position of slave post 175b to be slidably adjusted along rotation shaft 170. Split rotation bearing 250 may be, for example, a plastic bearing.

Typically, a rotation shaft for a row of reflectors and receivers is supported by one master post 275a and about three to about five slave posts 275b, but any suitable number and combination of master posts 275a and slave posts 275b may be used.

Although the example support structure 130 just described is shown in the figures supporting reflectors and receivers using particular example reflector supports and receiver supports, any suitable configuration of reflector and receiver supports may be used with the adjustable support structure disclosed herein.

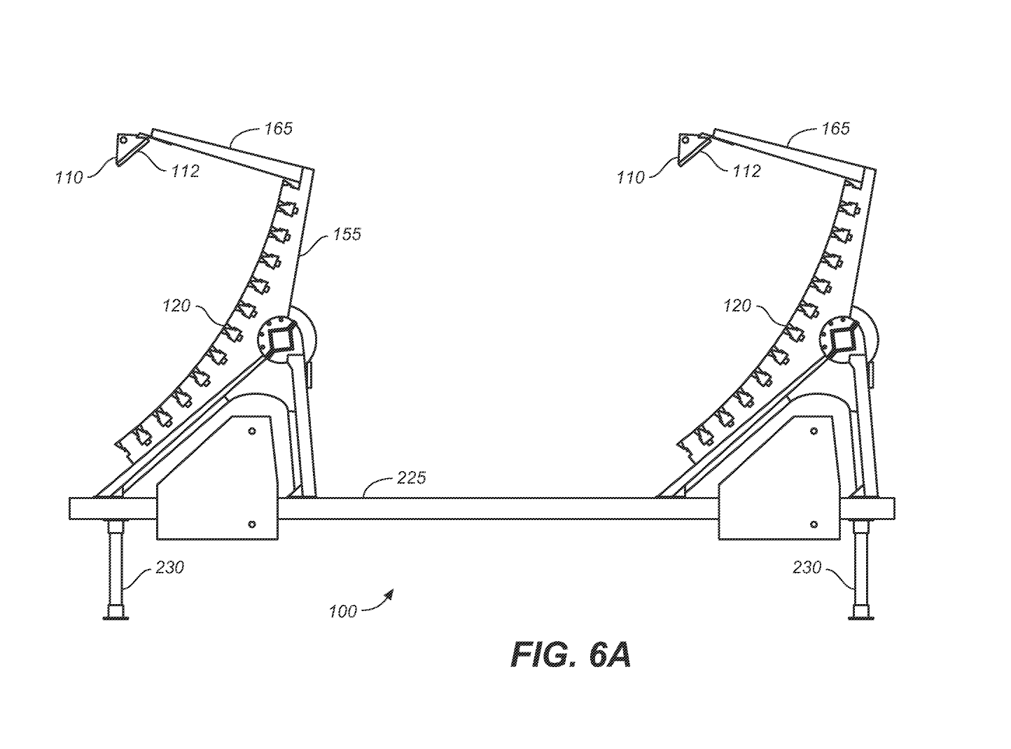

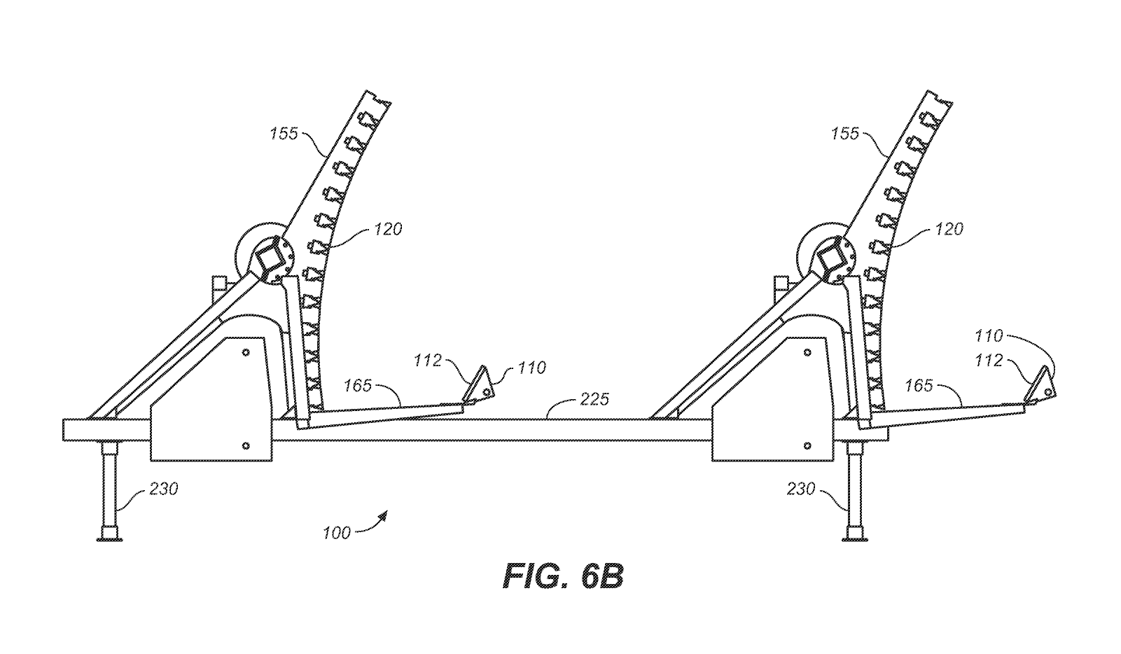

As shown in FIGS. 6A and 6B, the example solar energy collector 100 of FIGS. 1A and 1B may have a total rotational range of motion of, for example, about 140 degrees or more. FIG. 6A shows the solar energy collector 100 with its reflectors and receivers rotated into a position with the optical axes of the reflectors oriented at about 75 degrees from vertical in a forward direction. This orientation may be used as a safe position, because it may minimize the amount of solar radiation incident on surfaces 112 of receivers 110. FIG. 6B shows a solar energy collector 100 with its reflectors and receivers rotated into a position with the optical axes of the reflectors oriented at about 85 degrees from vertical in a backward direction. This orientation may be used as a stow position to prevent condensation of dew on the reflectors at night, because it minimizes the exposure of the reflectors to the night sky.

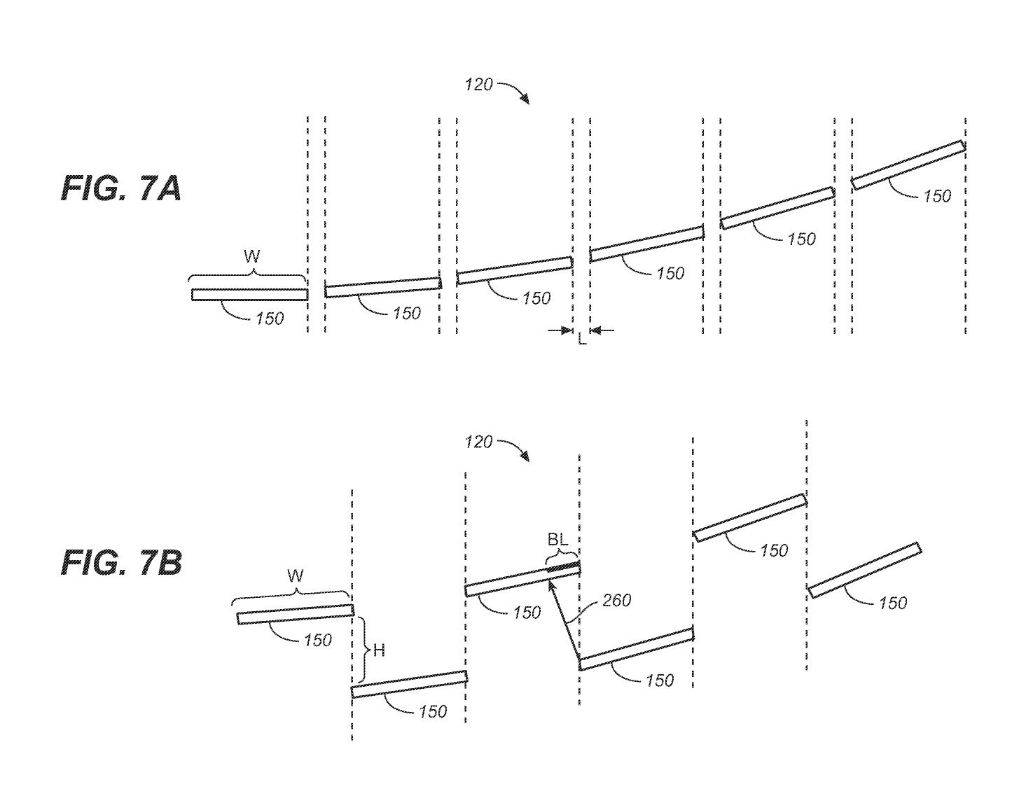

Referring now to FIGS. 7A and 7B, in some variations reflectors 120 formed from linear reflective elements 150 are configured to reduce the wind resistance of (or wind load on) the reflector. This may involve, for example, spacing the linear reflective elements apart vertically, horizontally, or vertically and horizontally to provide gaps through which wind may pass or to otherwise alter the aerodynamics of the reflector to reduce wind load.

FIG. 7A shows a schematic side view of a reflector 120 comprising linearly extending reflective elements 150 (with long axes extending into the page) positioned to form a substantially parabolic reflector 120. Reflective elements 150 have widths W and are horizontally spaced apart from each other by lengths L to provide gaps through which wind may pass. The wind load on this reflector 120 may be reduced by increasing gap length L. However, this will reduce the collection efficiency of the reflector, because the same reflective area will require a larger footprint. (That is, solar radiation also passes through the gaps and is thus not collected). In some variations the dimensions W and L may be selected to reduce wind load by a desirable amount while maintaining solar radiation collection efficiency at or above a desired level. The width W of the linearly extending reflective elements 150 may be, for example, about 100 mm to about 200 mm. The horizontal spacing L between adjacent reflective elements may be, for example, about 0 mm to about 20 mm.

FIG. 7B shows a schematic side view of a reflector 120 comprising linearly extending reflective elements 150 (with long axes extending into the page) positioned to form a substantially parabolic reflector 120. Reflective elements 150 again have width W. Alternating reflective elements 150 are spaced vertically from each other by a distance H to provide gaps through which wind may pass. In this configuration, portions of the upper reflective elements 150 having lengths BL block solar radiation reflected by the lower reflective elements (for example, ray 260) from reaching the focus of the reflector 120. The wind load on this reflector 120 may be reduced by increasing gap heights H. However, as gap height H increases, the lengths BL of the blocking portions of the upper reflective elements increase, decreasing solar radiation collection efficiency. In some variations the dimensions W and H may be selected to reduce wind load by a desirable amount while maintaining solar radiation collection efficiency at or above a desired level. The width W of the linearly extending reflective elements 150 may be, for example, about 100 mm to about 200 mm. The vertical spacing H of adjacent reflective elements may be, for example, about 10 mm to about 100 mm.

Other variations may combine horizontal gaps of length L with vertical gaps of height H. In such variations, W, L, and H may be selected to reduce wind load by a desirable amount while maintaining solar radiation collection efficiency at or above a desired level. The width W of the linearly extending reflective elements 150 may be, for example, about 100 mm to about 200 mm, the horizontal spacing L between adjacent reflective elements may be, for example, about 0 mm to about 20 mm, and the vertical spacing H of adjacent reflective elements may be, for example, about 10 mm to about 100 mm.

In the variations described above, reflectors 120 comprise parallel rows of linearly extending reflective elements 150 which are, for example, each individually supported by a longitudinal reflector support 160. Alternatively, and as described below, reflective elements 150 may be arranged side-by-side on flexible panels. The flexible panels may then be supported by longitudinal reflector supports and transverse reflector supports similar to those described above. Such arrangements of reflective elements on flexible panels are referred to below as reflector-panel assemblies. A reflector 120 may comprise one or more such reflector-panel assemblies. For example, a reflector 120 may comprise two or more such reflector-panel assemblies arranged side-by-side transversely to the rotation axis of the solar energy collector.

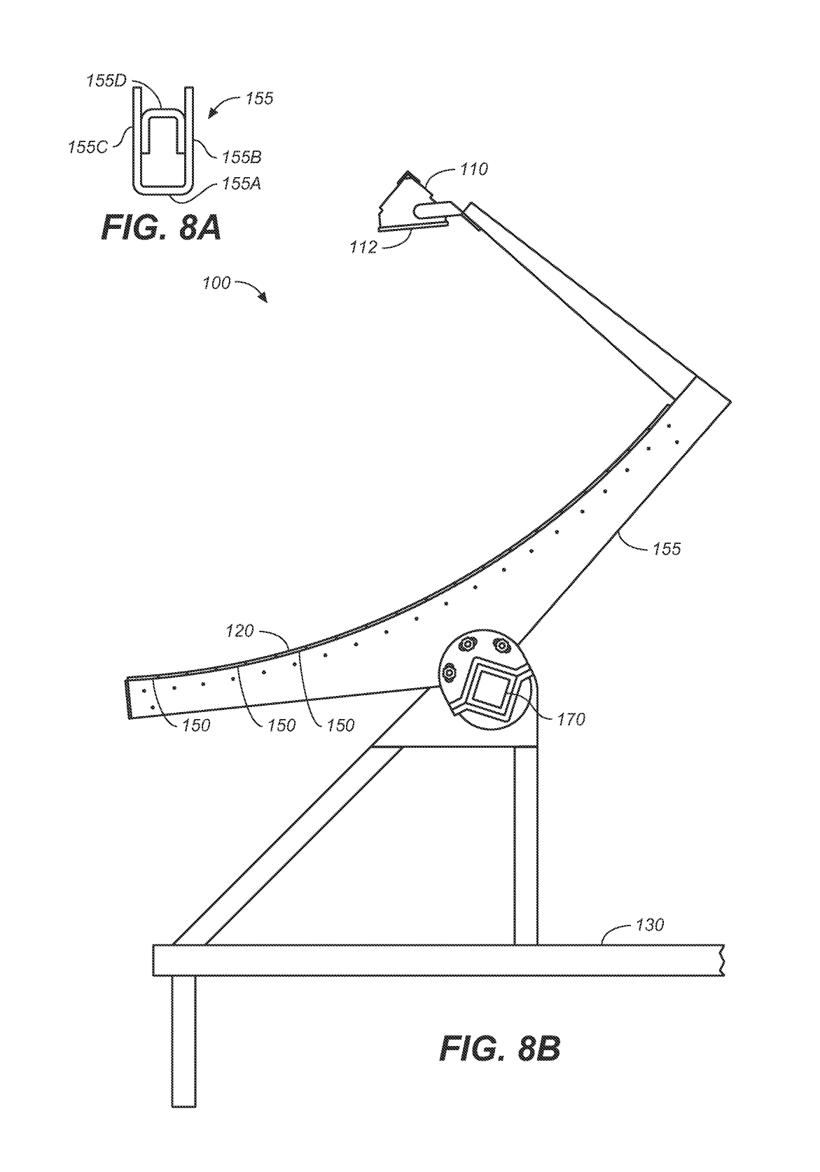

In variations of solar energy collector 100 comprising reflector-panel assemblies, the transverse reflector supports may impose a parabolic curve, an approximately parabolic curve, or any other suitable curve on the reflector-panel assemblies in a plane perpendicular to the rotation axis. The linearly extending reflective elements 150 may thereby be oriented to form a linear Fresnel (e.g., parabolic) trough reflector with its linear focus located at or approximate at the surface of receiver 110. Referring to FIGS. 8A and 8B, for example, transverse reflector supports 155 may each comprise a bottom panel 155A and two side walls 155B and 155C that form an approximately U-shaped cross section, with side walls 155B and 155C optionally of different heights. Cross-piece 155D braces side walls 155B and 155C. Upper edges of side walls 155B and 155C have, for example, a parabolic or approximately parabolic curvature. In the assembled solar energy collector (FIG. 8B), the upper edges of the transverse reflector support impose their curvature on the reflector-bed assemblies that they support.

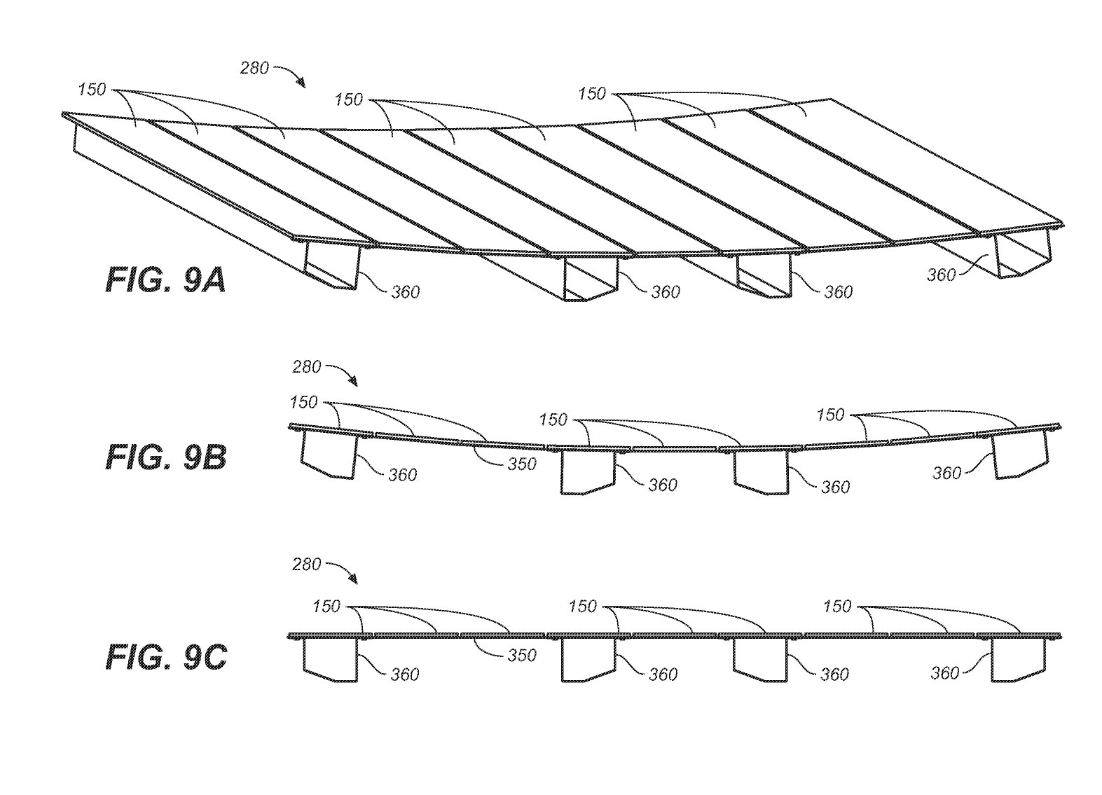

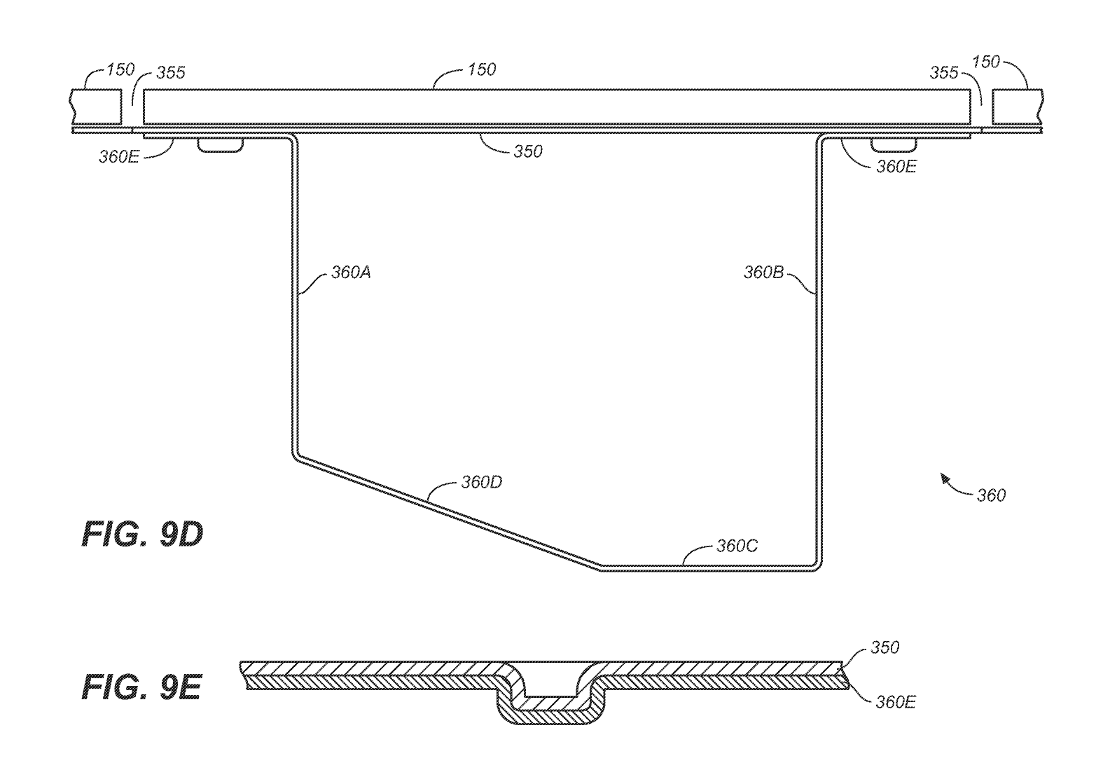

Referring now to FIGS. 9A-9D, each reflector-panel assembly 280 comprises a plurality of linearly extending reflective elements 150 arranged side-by side on a flexible panel 350. Flexible panel 350 maintains a flat configuration (FIG. 9C) if no external forces are applied to it, but may be flexed to assume a curved (e.g., parabolic or approximately parabolic) shape desired for reflector 120 by forces applied to the reflector-panel assembly by reflector supports. Gaps 355 (FIG. 9D) between adjacent reflective elements 150 are dimensioned, for example, to provide clearance that allows panel 350 to be bent into the desired curved profile without contact occurring between adjacent reflective elements. Panels 350 may bend primarily along regions corresponding to gaps 355, and may optionally be weakened along those regions by scoring or grooving, for example, to further facilitate bending. Panels 350 may be formed from steel sheet, for example, and when flat may have a width perpendicular to the long axes of reflective elements 150 of, for example, about 300 mm to about 1500 mm, typically about 675 mm, and a length parallel to the long axes of reflective elements 150 of, for example, about 600 mm to about 3700 mm, typically about 2440 mm. Any other suitable materials, dimensions, and configuration may also be used for panel 350.

Linearly extending reflective elements 150 may be attached to flexible panel 350 with, for example, an adhesive that coats the entire back surface of each reflective element 150. The adhesive coating may be applied, for example, directly to a reflective (e.g., silver and/or copper) layer located on the back surface of reflective element 150 or to a protective layer on the reflective layer. In such variations, the adhesive layer may protect the reflective layers from corrosion in addition to attaching the reflective elements to the panel. The use of such a protective adhesive layer may advantageously reduce any need to apply other protective coatings, such as paint layers, to the back surfaces of the reflective layers. The adhesive may be, for example, a spray-on adhesive such as, for example, 3MTM 94 CA spray adhesive available from 3M, Inc. The adhesive layer may have a thickness of, for example, about 0.05 mm to about 0.5 mm, typically about 0.2 mm. The spray-on adhesive may preferably be applied to only the back surfaces of the reflective elements, or to only the top surface of the flexible panel 350 to which the reflective elements are attached, rather than to both the back surfaces of the reflective elements and the top surface of the flexible panel. Alternatively, the spray-on adhesive may be applied to both the top surface of the flexible panel and the back surfaces of the reflective elements, but this may add process steps, complexity, and expense. Any other suitable adhesive, any suitable fastener, or any other suitable fastening method may also be used to attach reflective elements 150 to panel 350.

Referring again to FIGS. 9A-9D, each reflector-panel assembly 280 also comprises a plurality of longitudinal reflector supports 360 attached to the underside of panel 350 and running parallel to the long axes of reflective elements 150. As described in more detail below, in an assembled solar energy collector 100 the longitudinal reflector supports 360 are oriented perpendicularly to and attached to transverse reflector supports 155. Longitudinal reflector supports 360 thereby provide strength and rigidity to reflector-panel assemblies 280, and thus to reflector 120, along the rotational axis of the collector.

Referring now particularly to FIG. 9D, in the illustrated example each longitudinal reflector support 360 is formed from sheet steel into a trough-like configuration having a cross-section defined by parallel side walls 360A and 360B, a bottom panel 360C oriented perpendicularly to side wall 360B, and an (optionally) angled bottom wall 360D forming obtuse angles with bottom panel 360C and side wall 360A. In an alternative variation, not shown, reflector support 360 is formed from sheet steel into a trough-like configuration having two side walls and a bottom panel, with the side walls angling symmetrically inward from top to bottom so that the bottom panel is narrower than the open top of the trough. In this configuration, the longitudinal reflectors supports may be stacked in a nested manner for shipping.

Referring again to FIG. 9D, each longitudinal reflector support 360 also comprises flange panels 360E extending perpendicularly outward from side walls 360A and 360B. In the illustrated example, flange panels 360E of longitudinal reflector supports 360 are attached to flexible panel 350 with rivets 365. Any other suitable fastener, any suitable adhesive, or any other suitable fastening method may also be used to attach longitudinal reflector supports 360 to flexible panel 350. Longitudinal reflector supports 360 may be attached to flexible panel 350 with clinch joints as shown in FIG. 9E, for example, in which a portion of flexible panel 350 and a portion of longitudinal reflector flange panel 360E are overlaid and then formed to mechanically interlock. Such clinch joints may be formed with conventional sheet metal clinching tools, for example.

To facilitate bending of flexible panel 350 at gaps 355 between reflective elements 150, each longitudinal reflector support 360 may be arranged to underlie a single reflective element 150 as shown in FIG. 9D. Alternatively, longitudinal reflector supports 360 may be arranged to bridge gaps 355 between reflective elements 150.

Longitudinal reflector supports 360 may have a length of, for example, about 600 mm to about 3700 mm, typically about 2375 mm, a depth (panel 350 to bottom wall 360C) of, for example, about 25 mm to about 150 mm, typically about 50 mm, and a width (wall 360A to wall 360B) of, for example, about 25 mm to about 150 mm, typically about 75 mm. Any other suitable materials, dimensions, and configurations for longitudinal reflector supports 360 may also be used.

In the illustrated example each reflector-panel assembly 280 is attached to and supported at its ends by a pair of adjacent transverse reflector supports 155. Suitable methods and arrangements for accomplishing this may include those disclosed, for example, in U.S. patent application Ser. No. 13/619,881, filed Sep. 14, 2012, titled “Solar Energy Collector”; U.S. patent application Ser. No. 13/619,952, filed Sep. 14, 2012, also titled “Solar Energy Collector”; U.S. patent application Ser. No. 13/633,307, filed Oct. 2, 2012, also titled “Solar Energy Collector”; and U.S. patent application Ser. No. 13/651,246, filed Oct. 12, 2012, also titled “Solar Energy Collector”; all of which are incorporated herein by reference in their entirety. Any other suitable method or arrangement may also be used.

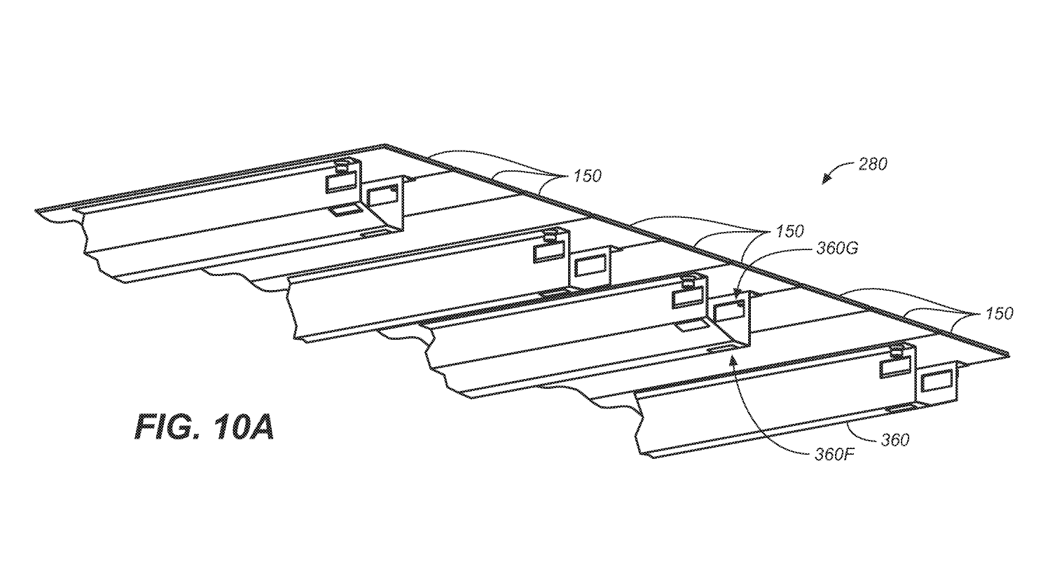

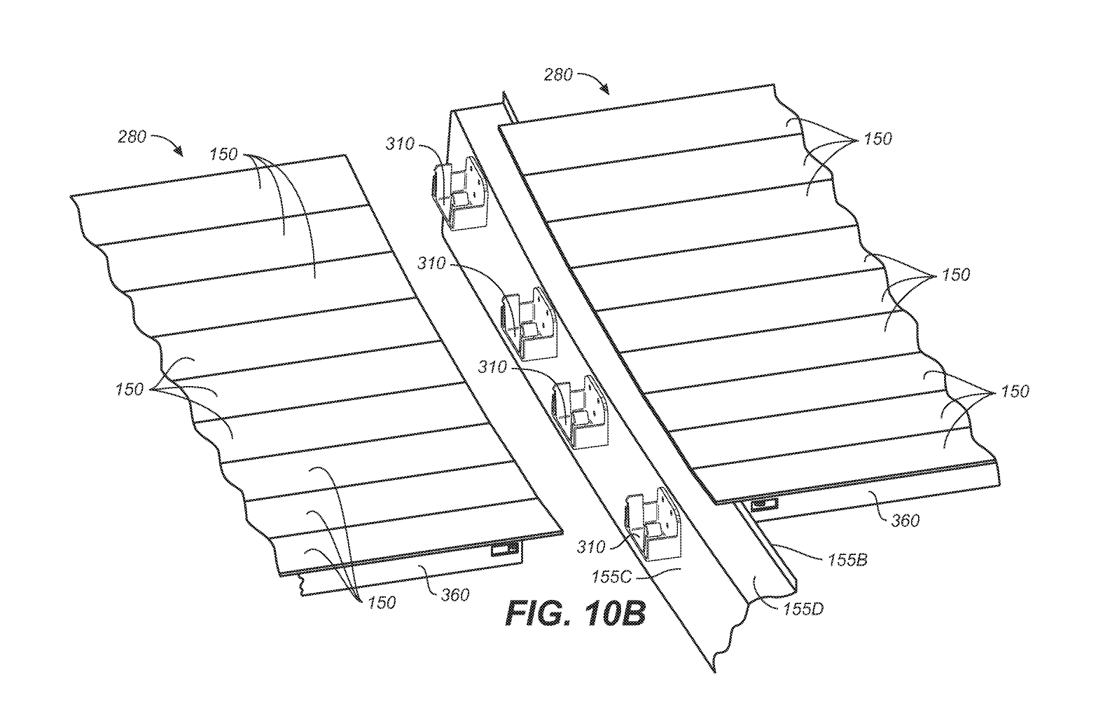

As shown in FIGS. 10A-10B, in the illustrated example opposite ends of the flexible panel 350 of each reflector-panel assembly are supported by the curved edge of a side wall 155B or the curved edge of a side wall 155C of a transverse reflector support 155. Longitudinal reflector supports 360 underlying the flexible panel 350 are attached to brackets 310 on the transverse reflector support 155. Thus attached, longitudinal reflector supports 360 and brackets 310 pull the ends of flexible panel 350 against the curved supporting edges of side walls 155B and 155C of the transverse reflector supports 155, forcing flexible panel 350 to conform to the shapes of those supporting edges and thereby orienting reflective elements 150 on flexible panel 350 to form a reflector having the desired curvature. As shown in FIG. 10B, each transverse reflector support 155 located at an intermediate position in solar energy collector 100 may support two longitudinally adjacent reflector-panel assemblies.

Longitudinal reflector supports 360 may be attached to brackets 310 with any suitable fastener, adhesive, or other fastening method. As in the illustrated example, further discussed below, longitudinal reflector supports 360 may snap-on to brackets 310 through the engagement of any suitable complementary interlocking features on supports 360 and on brackets 310. One or both of the complementary interlocking features may be configured to have sufficient elasticity to flex to allow a support 360 to be installed in a bracket 310 and then provide restoring forces that retain the complementary features in an interlocked configuration. Suitable complementary interlocking features may include, for example, tabs and slots, hooks and slots, protrusions and recesses, and spring clips and slots.

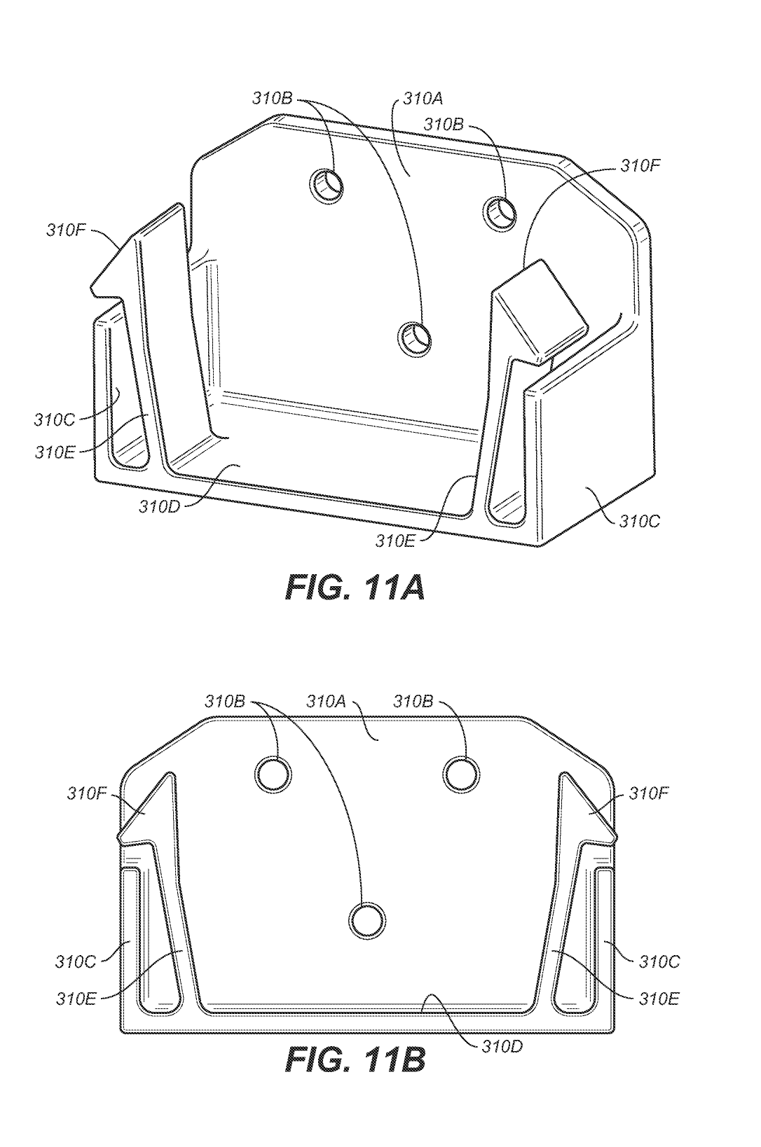

Referring now to FIGS. 11A-11B, in the illustrated example each bracket 310 comprises a back wall 310A to be attached to a transverse reflector support via fastener openings 310B, side walls 310C attached to opposite sides of back wall 310A and oriented perpendicularly outward from back wall 310A, bottom wall 310D attached to and oriented perpendicularly to back wall 310A and to side walls 310C, and elastic spring clips 310E each attached to bottom wall 310 adjacent to and angling toward a corresponding side wall 310C. Each spring clip 310E has a triangle shaped protrusion 310F that projects outward toward the nearest side wall 310C.

Referring again to FIGS. 10A-10B as well as to FIGS. 11A-11B, the end of each longitudinal reflector support 360 comprises bottom slots 360F and side slots 360G. During snap-on attachment of a longitudinal reflector support 360 to a bracket 310, spring clips 310E on the bracket are inserted through bottom slots 360F of the longitudinal support 360 until protrusions 310F on the spring clips protrude through and engage side slots 360G on the longitudinal support to retain the longitudinal support in the bracket. In this process the spring clips 310E are initially deflected from their equilibrium positions by contact with the inner surfaces of longitudinal support side walls 360A and 360B, then return toward their equilibrium positions when spring clip protrusions 310F snap through side slots 360G. In the latter configuration the bottom surfaces of triangular protrusions 310F engage lower edges of side slots 360G, interlocking the bracket and the longitudinal support. In an alternative version, not shown, brackets 310 may comprise spring clips that enter and engage side slots or other side apertures in longitudinal reflector support 360 from outside the reflector support, rather than from inside as shown in the figures.

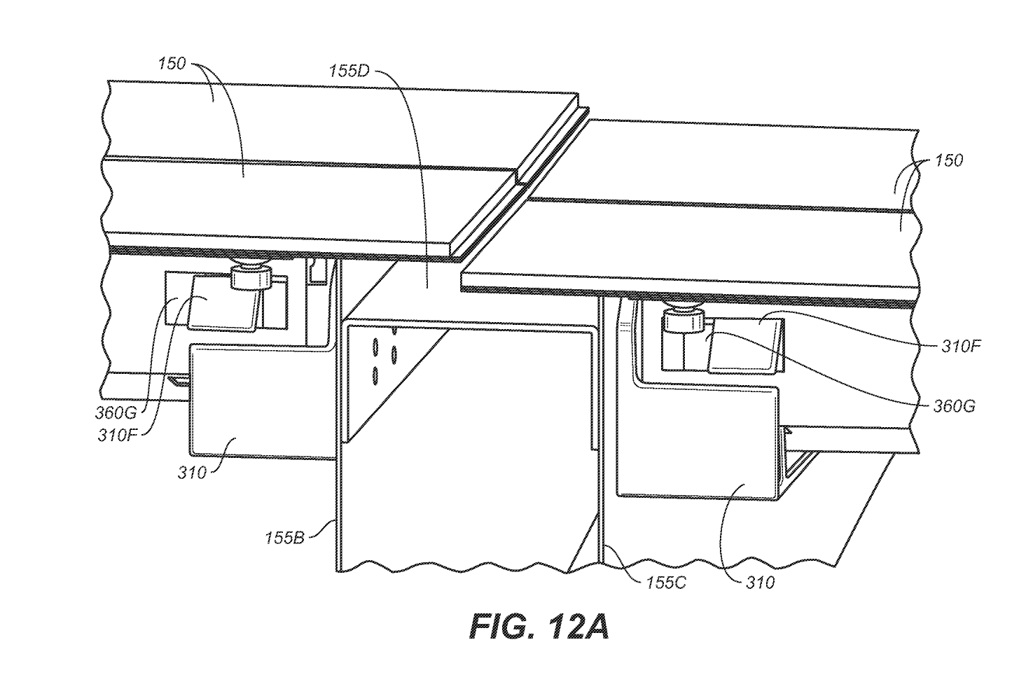

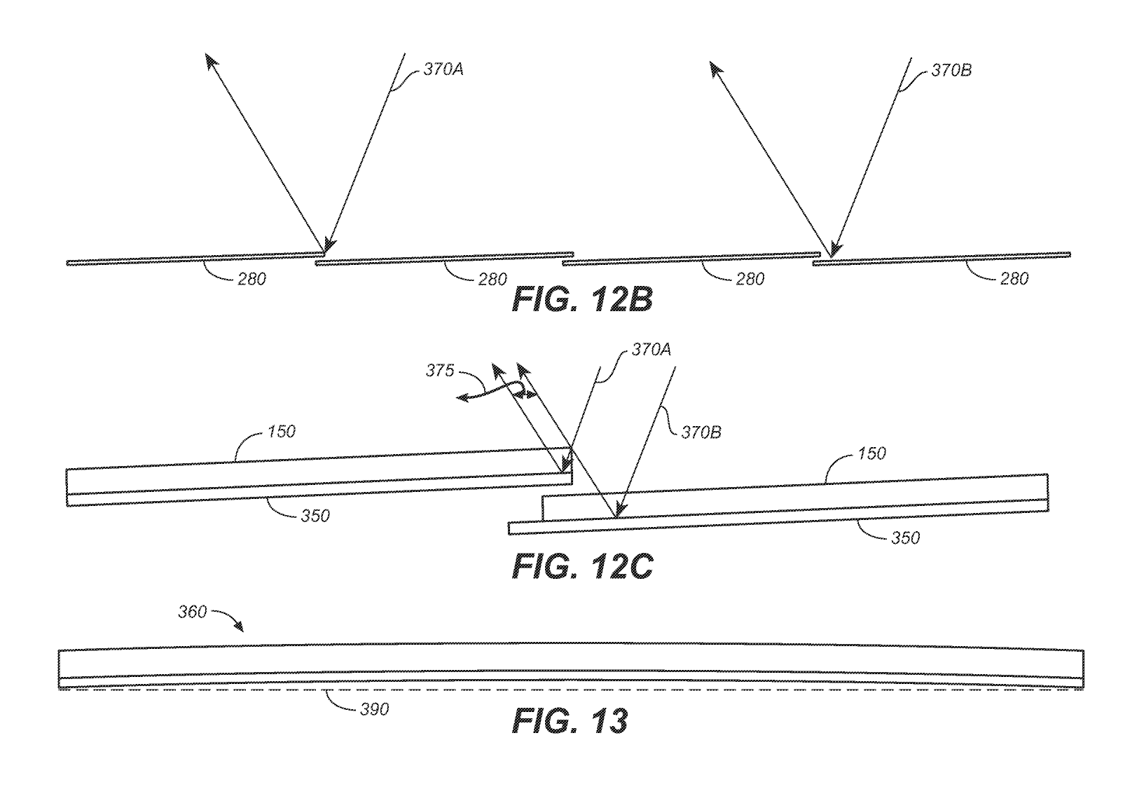

FIG. 12A shows two reflector-panel assemblies 280 attached to a transverse reflector support as just described. In the illustrated example, side slots 360G extend along longitudinal support 360 for a distance greater than the engaged width of bracket spring clip protrusion 310F. This allows the spring clip to move along the side slot to accommodate misalignment of, for example, bracket 310 or longitudinal support 360.

Brackets 310 may be formed, for example, form molded plastic, sheet steel, or any other suitable material. Although the illustrated snap-on configuration just described may be advantageous, any other suitable configuration for brackets 310 may also be used. Further, the use of brackets 310 is not required. As noted above, any suitable method for attaching reflector-panel assemblies 280 to transverse support 155 may be used.

Two coplanar reflector-panel assemblies arranged in line along the rotation axis and attached end-to-end to a shared transverse reflector support 155 are generally spaced apart by a small gap to accommodate thermally induced expansion and contraction of the collector and to provide mechanical design tolerances. The gap between the reflector-panel assemblies does not reflect light and consequently behaves like a shadow on the reflector, which may be projected by the reflector onto the receiver. The shadow on the receiver resulting from the gap may degrade performance of solar cells on the receiver similarly to as described above with respect to shadows cast by receiver supports.

Referring now to FIGS. 12A-12C, in the illustrated example two reflector-panel assemblies are arranged in line along the rotation axis and attached to a shared transverse reflector support 155 with their adjacent ends vertically offset from each other along the optical axis of the reflector, rather than coplanar. The vertical offset of the adjacent ends of the reflector-panel assemblies occurs because they are supported by transverse reflector support side walls 155B and 155C of different heights. This vertical offset allows the adjacent ends of the reflector-panel assemblies to be placed closer together or even to overlap as shown in FIGS. 12B-12C, without risk of mechanical interference between the adjacent reflector-panel assemblies. Typically, the lower reflector-panel assembly end is positioned under the upper reflector-panel assembly end.

In the illustrated example, each reflector-panel assembly is supported at one end by a tall side wall 155B of one transverse reflector support 155, and at the other end by a short side wall 155C of another transverse reflector support 155, with adjacent ends of the reflector-panel assemblies vertically offset rather than coplanar. As shown in FIG. 12B, for example, the reflector-panel assemblies may be arranged in a repeating pattern in which all of the reflector-panel assemblies are tilted in the same direction and adjacent ends of reflector-panel assemblies are vertically offset and optionally overlapped in a pattern similar to roof shingles. Typically, the solar energy collector is oriented so that the higher end of each reflector-panel assembly is closer to the equator than is its lower end.

If reflective elements 150 are front surface reflectors, then in the offset reflector-panel geometry just described parallel rays 370A and 370B (FIGS. 12B-12C) may be reflected from the ends of adjacent reflector-panel assemblies with no gap between the rays regardless of the position of the sun in the sky. If instead reflective elements 150 are rear surface reflectors, then parallel rays 370A and 370B may be reflected from the ends of adjacent reflector-panel assemblies with a gap 375 resulting from the side edge of the upper reflector-panel assembly blocking reflection from the lower reflector-panel assembly. When the sun is located directly above the reflector, gap 375 has zero width. If the reflector is oriented so that the higher end of each reflector-panel assembly is closer to the equator than is its lower end, then for other sun positions the width of gap 375 depends only on the sun position and on the thickness of the upper transparent layer (e.g., glass) on the rear surface reflector. The width of gap 375 may therefore be minimized by minimizing the thickness of the transparent layer on the reflector. If the reflector-panel assemblies were coplanar rather than having vertically offset ends, then gap 375 would include a contribution from the physical gap along the rotation axis between the ends of the reflector-panel assemblies as well as a contribution from the side edge of one reflector blocking reflection from the adjacent reflector. Consequently, in the illustrated example gap 375 may advantageously be smaller than would be the case for coplanar reflector-panel assemblies.

Non-uniform illumination of the receiver resulting from gaps between reflector-panel assemblies may also be reduced or eliminated by shaping the ends of reflector-panel assemblies to spread reflected light into what would otherwise by a shadow on the receiver resulting from the gap. For example, ends of otherwise coplanar reflector-panel assemblies may curve or bend downward (away from the incident light), so that light rays are reflected in a crossing manner from the ends of the adjacent reflector-panel assemblies toward the receiver, blurring the shadow from the gap.

The force of gravity may make reflector-panel assemblies 280 sag between their supporting transverse reflector supports 155, and thereby cause each reflector-panel assembly to assume a slightly concave curvature along the rotation axis of the collector, distorting the shapes of reflectors 120. The resulting periodic concave curvature of the reflectors along the long axis of the solar energy collector may make the illumination of the receiver less uniform along its long axis, and consequently reduce the efficiency with which solar cells in the receiver generate electricity. Referring now to FIG. 13, the tendency of reflector-panel assemblies to sag may be countered by using longitudinal reflector supports 360 that, in their free state unattached to flexible panel 350, are “pre-bent” to have a slight convex curvature upward. In FIG. 13, this curvature is shown by comparison of the bowed lower surface of longitudinal support 360 to the adjacent dashed reference straight line 390. This curvature of the longitudinal reflector support 360 is chosen to have a shape that compensates for the sagging caused by the force of gravity when the reflector-panel assembly is attached to the collector. That is, for these pre-bent longitudinal reflector supports 360 (and thus pre-bent reflector-panel assemblies 280), when they are attached to the collector the sag caused by the force of gravity pulls the reflector-panel assembly into a flat configuration along the long axis of the collector rather than into a concave curvature. (The transverse concentrating curvature of the reflector-panel assemblies is not significantly affected). This flat configuration along the long axis produces more uniform illumination of the receiver along its long axis, improving performance of the collector.

The influence of gravity on the shapes of the reflector-panel assemblies may depend on the orientation of the collector and may, for example, be different for orientations corresponding to operation at solar noon, early morning, or early evening. The “pre-bend” necessary to counter sagging may consequently also depend on the orientation of the collector. In such cases, the “pre-bend” may preferably be selected to eliminate sagging at solar noon.

Where not otherwise specified, structural components of solar energy collectors disclosed herein may be formed, for example, from 16 gauge G-90 sheet steel, or from hot dip galvanized ductile iron castings, or from galvanized weldments and thick sheet steel.

This disclosure is illustrative and not limiting. Further modifications will be apparent to one skilled in the art in light of this disclosure and are intended to fall within the scope of the appended claims. All publications and patent application cited in the specification are incorporated herein by reference in their entirety.

What is claimed is:

1. A solar energy collector comprising:
a first row of one or more trough reflectors extending along and attached to a first rotation shaft;
a second row of one or more trough reflectors extending along and attached to a second rotation shaft arranged side-by-side with the first rotation shaft and oriented parallel to the first rotation shaft;
a first transverse support beam underlying both the first and the second rotation shafts; and
a second transverse support beam underlying both the first and the second rotation shafts and spaced apart from the first transverse support beam along the rotation shafts;
wherein
the first rotation shaft is pivotably supported by a first bearing on a post extending upward from the first transverse support beam and pivotably supported and driven by a first slew drive on a post extending upward from the second transverse support beam, and the first rotation shaft passes through the center of the first bearing and through the center of the first slew drive;
the second rotation shaft is pivotably supported by a second bearing on a post extending upward from the first transverse support beam and pivotably supported and driven by a second slew drive on a post extending upward from the second transverse support beam, and the second rotation shaft passes through the center of the second bearing and through the center of the second slew drive; and
the positions of the first bearing and the first slew drive along the first rotation shaft and of the second bearing and the second slew drive along the second rotation shaft are adjustable to match the positions of the first and second transverse support beams to the positions of load bearing elements of a surface underlying the solar energy collector.

2. The solar energy collector of claim 1, wherein the positions of the first bearing and the first slew drive along the first rotation shaft and of the second bearing and the second slew drive along the second rotation shaft are slidably adjustable.

3. The solar energy collector of claim 1, wherein the underlying surface is a roof of a building.

4. The solar energy collector of claim 1, wherein the first and second transverse support beams are oriented parallel to each other.

5. The solar energy collector of claim 4, wherein the first and second transverse support beams are oriented perpendicularly to the rotation shafts.

6. The solar energy collector of claim 1, comprising transverse reflector supports attached to and extending transversely to the rotation shafts to support the trough reflectors.

7. The solar energy collector of claim 6, comprising a plurality of receivers, each receiver supported above a corresponding trough reflector by one or more receiver supports extending upward from transverse reflector supports supporting the corresponding trough reflector, each receiver fixed in position with respect to its corresponding trough reflector.

8. The solar energy collector of claim 1, wherein each trough reflector comprises a plurality of linearly extending reflective elements oriented with their long axes parallel to the trough reflector's rotation shaft, arranged side-by-side in a direction transverse to that rotation shaft, and fixed in position with respect to each other.

9. The solar energy collector of claim 1, wherein along each rotation shaft the trough reflectors are arranged end-to-end with ends of adjacent trough reflectors vertically offset with respect to each other.

10. The solar energy collector of claim 9, wherein along each rotation shaft the trough reflectors are arranged to form a repeating pattern of tilted trough reflectors.

11. The solar energy collector of claim 10, wherein the ends of adjacent trough reflectors overlap.

12. The solar energy collector of claim 10, wherein for each pair of adjacent vertically offset trough reflector ends the upper trough reflector is located further from the equator than is the lower trough reflector.

13. The solar energy collector of claim 1, comprising transverse reflector supports attached to and extending transversely to the rotation shafts to support the trough reflectors, wherein:
each trough reflector comprises a plurality of linearly extending reflective elements arranged side-by-side on an upper surface of a flexible panel and oriented parallel to the trough reflector's rotation shaft; and
attachment of the trough reflectors to the transverse reflector supports forces ends of the flexible panels against curved edges of the transverse reflector supports to thereby impose a desired concentrating curvature on the trough reflectors.

14. The solar energy collector of claim 13, comprising a plurality of receivers, each receiver supported above a corresponding trough reflector by one or more receiver supports extending upward from transverse reflector supports supporting the corresponding trough reflector, each receiver fixed in position with respect to its corresponding trough reflector.

15. The solar energy collector of claim 13, wherein along each rotation shaft the trough reflectors are arranged end-to-end with ends of adjacent trough reflectors vertically offset with respect to each other.

16. The solar energy collector of claim 15, wherein along each rotation shaft the trough reflectors are arranged to form a repeating pattern of tilted trough reflectors.

17. The solar energy collector of claim 15, wherein the ends of adjacent trough reflectors overlap.

18. The solar energy collector of clam 16, wherein for each pair of adjacent vertically offset trough reflector ends the upper trough reflector is located further from the equator than is the lower trough reflector.

19. The solar energy collector of claim 1, comprising a plurality of longitudinal reflector supports extending parallel to each rotation shaft to support the trough reflectors and a plurality of transverse reflector supports extending transversely from each rotation shaft to support the longitudinal reflector supports, each transverse reflector support located at or near an end of a trough reflector, wherein:
in a free state unattached to the solar energy collector, the longitudinal reflector supports have a curvature that, in the assembled solar energy collector, is flattened or substantially flattened by the force of gravity, the free-state curvature of the longitudinal reflector supports thereby compensating for the force of gravity on the trough reflectors to prevent sagging of each trough reflector between its supporting transverse reflector supports.

20. The solar energy collector of claim 19, wherein along each rotation shaft the trough reflectors are arranged end-to-end with ends of adjacent trough reflectors vertically offset with respect to each other.

21. The solar energy collector of claim 20, wherein along each rotation shaft the trough reflectors are arranged to form a repeating pattern of tilted trough reflectors.

22. The solar energy collector of claim 21, wherein the ends of adjacent trough reflectors overlap.

23. The solar energy collector of clam 21, wherein for each pair of adjacent vertically offset trough reflector ends the upper trough reflector is located further from the equator than is the lower trough reflector.

24. The solar energy collector of claim 19, wherein:
each trough reflector comprises a plurality of linearly extending reflective elements arranged side-by-side on an upper surface of a flexible panel and oriented parallel to the trough reflector's rotation shaft; and
attachment of the longitudinal reflector supports to the transverse reflector supports forces ends of the flexible panels against curved edges of the transverse reflector supports to thereby impose a desired concentrating curvature on the trough reflectors.

25. The solar energy collector of claim 24, comprising a plurality of receivers, each receiver supported above a corresponding trough reflector by one or more receiver supports extending upward from transverse reflector supports supporting the corresponding trough reflector, each receiver fixed in position with respect to its corresponding trough reflector.

26. The solar energy collector of claim 25, wherein along each rotation shaft the trough reflectors are arranged end-to-end with ends of adjacent trough reflectors vertically offset with respect to each other.

27. The solar energy collector of claim 26, wherein along each rotation shaft the trough reflectors are arranged to form a repeating pattern of tilted trough reflectors.

28. The solar energy collector of claim 27, wherein the ends of adjacent trough reflectors overlap.

29. The solar energy collector of clam 27, wherein for each pair of adjacent vertically offset trough reflector ends the upper trough reflector is located further from the equator than is the lower trough reflector.
